(19) United States
(12) Patent Application Publication
(10) Pub. No.: US 2025/0299223 A1
(43) Pub. Date: Sep. 25, 2025

(54) PRIVILEGE INFORMATION ISSUING APPARATUS, SYSTEM, AND METHOD, AND COMPUTER READABLE MEDIUM

(71) Applicant: NEC Corporation, Minato-ku, Tokyo (JP)

(72) Inventors: Eri KOKAJI, Tokyo (JP); Kazufumi HOSHI, Tokyo (JP); Yurie HOSHI, Tokyo (JP); Hiroaki KUJIRAI, Tokyo (JP)

(73) Assignee: NEC Corporation, Minato-ku, Tokyo (JP)

(21) Appl. No.: 18/861,906

(22) PCT Filed: Jul. 28, 2022
(86) PCT No.: PCT/JP2022/029081

§ 371 Date: Oct. 31, 2024

(51) Int. Cl. G06Q 30/0251; G06Q 20/20; G07C 9/32

(52) U.S. Cl. CPC G06Q 30/0252; G06Q 20/209; G07C 9/32

(57) ABSTRACT

A privilege information issuing apparatus according to the present invention includes: an authentication control unit that controls identity authentication for a user who has purchased entry qualification information with which the user is able to enter an event venue through the identity authentication at a time of a payment by the user at a commercial facility in a neighborhood of the event venue; an issuing unit that issues privilege information related to utilization of the event venue on the basis of information that is attributable to the payment in a case where the identity authentication has been successful; and a notification unit that notifies a terminal of the user of the issued privilege information.

### TECHNICAL FIELD

The present disclosure relates to a privilege information issuing apparatus, a system, a method, and a program.

### BACKGROUND ART

Patent Literature 1 discloses a technology related to a points granting system. According to Patent Literature 1, a user who belongs to a predetermined group visits a store in a cooperative relationship with the group and holds a user terminal over a store terminal. The user terminal reads a store ID from the store terminal and transmits a user ID and the store ID to a store information management server. The store information management server transmits the user ID to a user information management server associated with the received store ID. The user information management server grants points to points information associated with the received user ID.

Here, a unique economic zone can be formed in a predetermined region including an event venue and commercial facilities around the event venue. In recent years, provision of services using identity authentication such as biometric authentication including face authentication has been put into practical use.

### CITATION LIST

### Patent Literature

Patent Literature 1: International Patent Publication No. WO2021/111524

### SUMMARY OF INVENTION

### Technical Problem

Here, activating a region including an event venue and commercial facilities around the event venue by mutually sending customers therebetween is required. For example, there is a problem of encouraging purchasers of entry qualification information such as an entry ticket for an event to use commercial facilities in the surroundings.

In view of the above-described problem, an object of the present disclosure is to provide a privilege information issuing apparatus, a system, a method, and a program for promoting a purchaser of entry qualification information for an event using commercial facilities around an event venue by presenting privileges related to utilization of the event venue resulting from utilization of the commercial facilities.

### Solution to Problem

A privilege information issuing apparatus according to the present disclosure includes:
an authentication control means for controlling identity authentication for a user who has purchased entry qualification information with which the user is able to enter an event venue through the identity authentication at a time of a payment by the user at a commercial facility in a neighborhood of the event venue;
an issuing means for issuing privilege information related to utilization of the event venue on the basis of information that is attributable to the payment in a case where the identity authentication has been successful; and
a notification means for notifying a terminal of the user of the issued privilege information.

A privilege information issuing system according to the present disclosure includes:
a storage apparatus that stores entry qualification information with which a user is able to enter an event venue through identity authentication and identity authentication information for registration of the user who has purchased the entry qualification information in an associated manner; and
a privilege information issuing apparatus that is connected to the storage apparatus,
in which the privilege information issuing apparatus includes
an authentication control means for controlling the identity authentication with reference to the storage apparatus using identity authentication information for authentication acquired from the user at a time of a payment by the user at a commercial facility in a neighborhood of the event venue,
an issuing means for issuing privilege information related to utilization of the event venue on the basis of information that is attributable to the payment in a case where the identity authentication has been successful, and
a notification means for notifying a terminal of the user of the issued privilege information.

A privilege information issuing method according to the present disclosure includes, by a computer:
controlling identity authentication for a user who has purchased entry qualification information with which the user is able to enter an event venue through the identity authentication at a time of a payment by the user at a commercial facility in a neighborhood of the event venue;
issuing privilege information related to utilization of the event venue on the basis of information that is attributable to the payment in a case where the identity authentication has been successful; and
notifying a terminal of the user of the issued privilege information.

A privilege information issuing program according to the present disclosure causes a computer to execute:
authentication control processing of controlling identity authentication for a user who has purchased entry qualification information with which the user is able to enter an event venue through the identity authentication at a time of a payment by the user at a commercial facility in a neighborhood of the event venue;
issuing processing of issuing privilege information related to utilization of the event venue on the basis of information that is attributable to the payment in a case where the identity authentication has been successful; and
notification processing of notifying a terminal of the user of the issued privilege information.

### Advantageous Effects of Invention

According to the present disclosure, it is possible to provide a privilege information issuing apparatus, a system, a method, and a program for promoting a purchaser of entry qualification information for an event using commercial facilities around an event venue by presenting privileges related to utilization of the event venue resulting from utilization of the commercial facilities.

### BRIEF DESCRIPTION OF DRAWINGS

FIG. 1 is a block diagram illustrating a configuration of a privilege information issuing apparatus according to a first example embodiment.

FIG. 2 is a flowchart illustrating a flow of a privilege information issuing method according to the first example embodiment.

FIG. 3 is a block diagram illustrating an overall configuration of a privilege information issuing system according to a second example embodiment.

FIG. 4 is a block diagram illustrating a configuration of an authentication apparatus according to the second example embodiment.

FIG. 5 is a block diagram illustrating a configuration of a user terminal according to the second example embodiment.

FIG. 6 is a block diagram illustrating a configuration of an entry control terminal according to the second example embodiment.

FIG. 7 is a block diagram illustrating a configuration of a payment terminal according to the second example embodiment.

FIG. 8 is a block diagram illustrating a configuration of a privilege information issuing apparatus according to the second example embodiment.

FIG. 9 is a flowchart illustrating a flow of member information registration processing according to the second example embodiment.

FIG. 10 is a flowchart illustrating a flow of face information registration processing performed by the authentication apparatus according to the second example embodiment.

FIG. 11 is a sequence diagram illustrating a flow of entry qualification information registration processing according to the second example embodiment.

FIG. 12 is a flowchart illustrating a flow of face authentication processing performed by the authentication apparatus according to the second example embodiment.

FIG. 13 is a sequence diagram illustrating a flow of face authentication payment and privilege information issuing processing according to the second example embodiment.

FIG. 14 is a flowchart illustrating a flow of the face authentication payment and privilege information issuing processing according to the second example embodiment.

FIG. 15 is a diagram illustrating a display example of issued privilege information according to the second example embodiment.

FIG. 16 is a diagram illustrating a display example of issued privilege information according to the second example embodiment.

FIG. 17 is a block diagram illustrating an overall configuration of a privilege information issuing system according to a third example embodiment.

FIG. 18 is a flowchart illustrating a flow of face authentication payment and privilege information issuing processing according to the third example embodiment.

FIG. 19 is a diagram illustrating a display example of issued privilege information according to the third example embodiment.

FIG. 20 is a diagram illustrating a display example of issued privilege information according to the third example embodiment.

FIG. 21 is a block diagram illustrating a configuration of a privilege information issuing apparatus according to a fourth example embodiment.

FIG. 22 is a flowchart illustrating a flow of face authentication payment and privilege information issuing processing according to the fourth example embodiment.

FIG. 23 is a diagram illustrating a display example of issued privilege information according to the fourth example embodiment.

FIG. 24 is a diagram illustrating a display example of privilege information issuing conditions according to another example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated descriptions will be omitted as necessary for clarity of description.

### First Example Embodiment

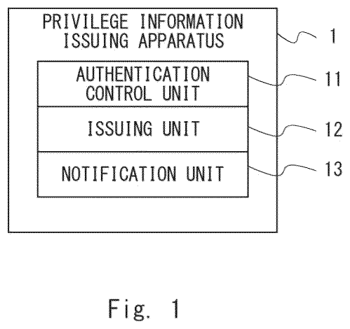

FIG. 1 is a block diagram illustrating a configuration of a privilege information issuing apparatus 1 according to a first example embodiment. The privilege information issuing apparatus 1 is an information issuing apparatus that issues privilege information related to utilization of an event venue at a time of a payment accompanied by the present authentication is made at a commercial facility in the neighborhood of the event venue. Here, the “commercial facilities” are stores that sell goods or provide services, accommodation facilities, public transportation stations, or the like. The commercial facilities according to the first embodiment are assumed to be present in a region within a predetermined range from an event venue where a predetermined event is held, that is, in the neighborhood of the event venue. In addition, the “privilege information” is electronic data to which a right to enjoy a paid privilege or a free privilege in an available facility has been given. The privilege information is, for example, value added information such as an electronic coupon or a point.

The privilege information issuing apparatus 1 includes an authentication control unit 11, an issuing unit 12, and a notification unit 13. The authentication control unit 11 controls identity authentication of a user who has purchased entry qualification information with which the user can enter an event venue through identity authentication at a time of a payment by the user at a commercial facility in the neighborhood of the event venue. Here, the “entry qualification information” is information with which an entry scheduled person (user) can enter the event venue through identity authentication. Here, the “identity authentication” is information processing of verifying authenticity of an individual by collating identity authentication information registered in advance with information acquired from the individual or input from the individual at the time of the authentication and determining that a degree of matching is equal to or greater than a threshold value. Although examples of the identity authentication include biometric authentication such as face authentication, collation of code information (such as an ID or a password) presented or input by the individual, and the like, the identity authentication is not limited thereto.

In a case where the identity authentication has been successful, the issuing unit 12 issues privilege information related to utilization of the event venue on the basis of information that is attributable to the payment. Here, examples of the “information that is attributable to the payment (in other words, information due to the payment)” include, but are not limited to, a payment price in the payment, a type of a purchased product or service in the payment, content of actions taken in relation to the payment, whether or not the privilege information has been used in the payment, and the like. Also, examples of the “privilege information related to the utilization of the event venue” include upgrading of a seat grade in the entry qualification information, a discount at a store in the event venue, and purchase or free provision of limited goods at the event venue. Alternatively, examples of the “privilege information related to utilization of the event venue” include, but are not limited to, a discount for the entry qualification information at the next event, granting of points that can be used at a store in the event venue, and the like.

The notification unit 13 notifies of a terminal of the user of the issued privilege information.

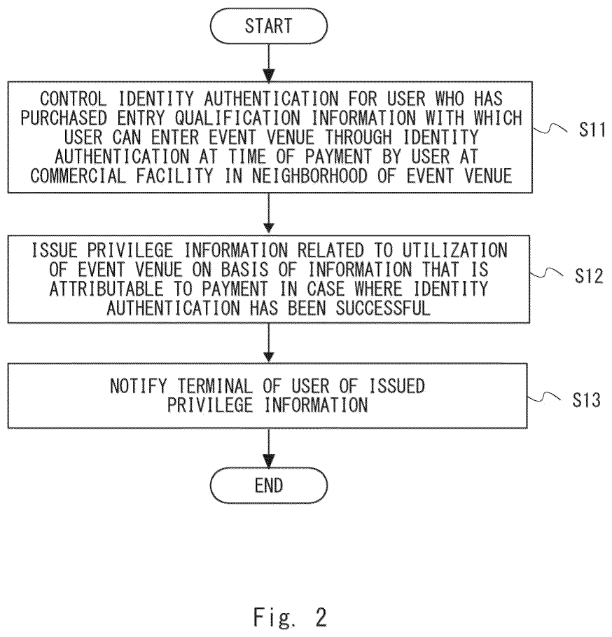

FIG. 2 is a flowchart illustrating a flow of privilege information issuing method according to the first example embodiment. First, the authentication control unit 11 controls identity authentication of the user who has purchased entry qualification information with which the user can enter an event venue through the identity authentication at a time of a payment by the user at a commercial facility in the neighborhood of the event venue (S11). Next, in a case where the identity authentication has been successful, the issuing unit 12 issues privilege information related to utilization of the event venue on the basis of information that is attributable to the payment (S12). Thereafter, the notification unit 13 notifies the terminal of the user of the issued privilege information (S13).

In this manner, according to the present embodiment, the user can purchase the entry qualification information for the event venue and obtain the privilege information related to utilization of the event venue as an incentive of utilization of the commercial facility in the surroundings. Therefore, the user is motivated to further use the event venue and the commercial facilities in the surroundings by the privilege information provided through the notification. In other words, it is possible to promote utilization of the commercial facilities by presenting the privilege related to the utilization of the event venue resulting from the utilization of the commercial facilities around the event venue to the purchaser of the entry qualification information for the event.

Note that the privilege information issuing apparatus 1 includes a processor, a memory, and a storage apparatus as configurations, which are not illustrated. In addition, the storage apparatus stores a computer program that implements processing of the privilege information issuing method according to the present example embodiment. Then, the processor reads a computer program or the like from the storage apparatus into the memory and executes the computer program. In this manner, the processor implements the functions of the authentication control unit 11, the issuing unit 12, and the notification unit 13.

Alternatively, each component of the privilege information issuing apparatus 1 may be implemented by dedicated hardware. In addition, some or all of the components of each apparatus may be implemented by general-purpose or dedicated circuitry, a processor, or a combination thereof. These may be configured of a single chip or may be configured of a plurality of chips connected via a bus. Some or all of the components of each apparatus may be implemented by a combination of the aforementioned circuitry or the like and a program. Furthermore, as the processor, a central processing unit (CPU), a graphics processing unit (GPU), a field-programmable gate array (FPGA), a quantum processor (quantum computer control chip), or the like can be used.

In a case where some or all of the components of the privilege information issuing apparatus 1 are implemented by a plurality of information processing apparatuses, circuits, or the like, the plurality of information processing apparatuses, circuits, or the like may be arranged in a centralized manner or in a distributed manner. For example, the information processing apparatuses, the circuits, or the like may be implemented in the form of a client server system, a cloud computing system, or the like in which they are connected to each other via a communication network. The functions of the privilege information issuing apparatus 1 may be provided in a software as a service (SaaS) format.

### Second Example Embodiment

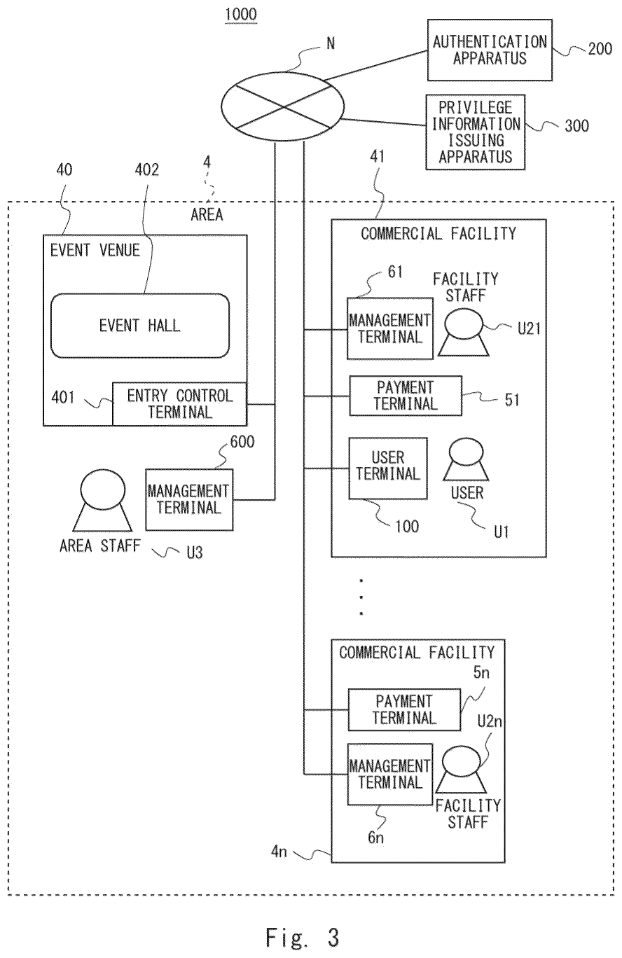

A second example embodiment is a specific example of the first example embodiment described above. FIG. 3 is a block diagram illustrating an overall configuration of a privilege information issuing system 1000 according to the second example embodiment. The privilege information issuing system 1000 is an information system that issues, for a user U1 who has purchased a paid electronic ticket (entry qualification information) for an event venue 40, privilege information on the basis of information that is attributable to payment at the time of face authentication payment at a commercial facility 41 or the like in the neighborhood. Here, the issued privilege information is electronic data with which a privilege related to utilization of the event venue can be enjoyed. Also, privilege information with a time limit can promote a consumption action in the commercial facility 41 or the like in the neighborhood of the event venue 40. Therefore, it is possible to promote cooperative utilization of the event venue and the facilities and to support revitalization of the area 4 including the event venue 40 and the commercial facilities 41 to 4n (n is a natural number that is equal to or greater than one) in the neighborhood thereof.

The event venue 40 is a site where a predetermined event is held. The “event” is a paid service provided at a certain time by collecting a large number of people. For example, the event is a sport game, a concert, an exhibition, an international conference, or the like, and may be watched or viewed by paid visitors, or may be participated in by the visitors themselves. Therefore, the event venue 40 is a facility such as a sport stadium, a sport ground, an arena, a theater, or a multiuse event hall, for example. The event venue 40 can also be referred to as a main facility or a core facility in the area 4.

It is assumed that the event venue 40 includes an event hall 402 and an entry control terminal 401 is installed at an entrance. The entry control terminal 401 is an information terminal that permits entry to the event venue 40 in a case where the user U1 has succeeded in the person authentication. Details of the entry control terminal 401 will be described later. Note that some users entering the event venue 40 may enter without passing through the entry control terminal 401. In other words, the event venue 40 may allow users who have purchased conventional tickets or the like to enter without using identity authentication such as face authentication. The event hall 402 is a place where an event is held, a sport ground, an audience seat, or the like.

The commercial facilities 41 to 4n are facilities in the surroundings and commercial facilities in the neighborhood of the event venue 40. The number of commercial facilities 41 and the like may be at least one or more. The commercial facility 41 and the like are facilities in a cooperative relationship with the side of the event venue 40. Therefore, business operators of the commercial facility 41 and the like are business partners of a business operator on the side of the event venue 40. Examples of the commercial facility 41 and the like include, but are not limited to, retail stores, restaurants, shopping streets, shopping malls, accommodation facilities, parking lots, bicycle-parking lots, amusement parks, and transportation stations (railway stations, bus stops, taxi lanes, ports, airports).

In each of the commercial facilities 41 to 4n, at least each of payment terminals 51 to 5n compatible with the payment using face authentication is installed. In addition, each of the facility staff U21 to U2n performs a management operation such as registration and the like of privilege information that can be used in each of the commercial facilities 41 to 4n using each of management terminals 61 to 6n. The facility staff U21 and the like may also be shop staff of the commercial facility 41 and the like. Alternatively, the facility staff U21 and the like may be a cooperative business operator on the side of the commercial facility 41 and the like. Therefore, the facility staff U21 and the like and the management terminal 61 and the like may not necessarily be present inside the commercial facility 41 and the like.

An area staff U3 who is a business operator who manages a business operation inside an area 4 including the event venue 40, the commercial facility 41, and the like registers privilege information related to utilization of the event venue 40 using a management terminal 600. Also, the area staff U3 may register privilege information that can be used at the commercial facility 41 or the like using the management terminal 600. Note that since it is possible to use known information processing apparatuses as the management terminals 61 to 6n and 600, illustration and detailed description will be omitted.

Here, the privilege information issuing system 1000 includes a user terminal 100, an authentication apparatus 200, a privilege information issuing apparatus 300, an entry control terminal 401, payment terminals 51 to 5n, and management terminals 61 to 6n and 600 the user terminal 100, the authentication apparatus 200, the privilege information issuing apparatus 300, the entry control terminal 401, the payment terminals 51 to 5n, and the management terminals 61 to 6n and 600 being communicatively connected via a network N. Here, the network N is a communication network including a wireless communication line and is, for example, the Internet, a wireless communication line network, a mobile phone line network, or the like. The network N may be of any type of communication protocol.

The authentication apparatus 200 is an information processing apparatus that manages face feature information of the user and performs face authentication. In response to a face authentication request received from the outside, the authentication apparatus 200 collates a face image or face feature information included in the request with the face feature information of each user, and returns the collation result (authentication result) to the request source.

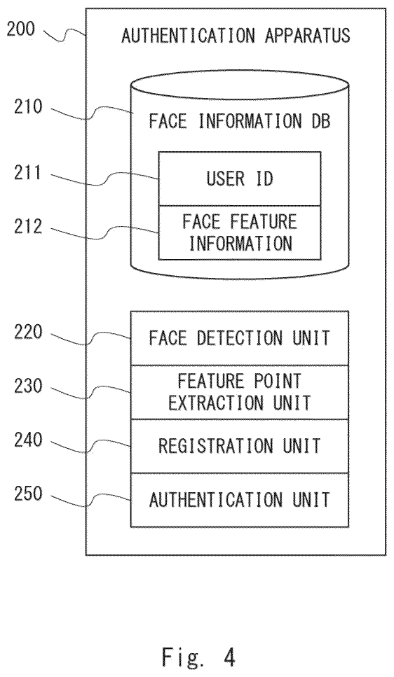

FIG. 4 is a block diagram illustrating the configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a set of feature points extracted from the face image. Note that the authentication apparatus 200 may delete the face feature information 212 in the face information DB 210 in response to a request from the user or the like corresponding to the face feature information 212. Alternatively, the authentication apparatus 200 may delete the face feature information 212 after elapse of a predetermined period from registration.

The face detection unit 220 detects a face region included in a registered image for registering face information, and outputs the face region to the feature point extraction unit 230. The feature point extraction unit 230 extracts feature points from the face region detected by the face detection unit 220, and outputs the face feature information to the registration unit 240. In addition, the feature point extraction unit 230 extracts feature points included in the face image received from the privilege information issuing apparatus 300 or the like, and outputs the face feature information to the authentication unit 250.

The registration unit 240 newly issues the user ID 211 at a time of registering the face feature information. The registration unit 240 registers the issued user ID 211 and the face feature information 212 extracted from the registered image in the face information DB 210 in association with each other. The authentication unit 250 performs face authentication using the face feature information 212. Specifically, the authentication unit 250 collates the face feature information extracted from the face image with the face feature information 212 in the face information DB 210. If the collation is successful, the authentication unit 250 specifies the user ID 211 associated with the collated face feature information 212. The authentication unit 250 returns the matching result of the face feature information to the request source as a face authentication result. Whether or not the pieces of face feature information match each other corresponds to whether or not authentication has been successful or failed. Note that the fact that the pieces of face feature information match each other refers to the case where the degree of matching is equal to or greater than a threshold value. In addition, it is assumed that the face authentication result includes the specified user ID if the face authentication has been successful.

Returning to FIG. 3, the description will be continued. The user U1 carries the user terminal 100 with himself/herself, operates the user terminal 100, is a purchaser of entry qualification information of an event that is held in the event venue 40, and is an entry scheduled person, a visitor, or a leaving person. Here, the “entry qualification information” is information proving that the user can enter the event venue through identity authentication.

The user terminal 100 is an information processing terminal that registers user information including the face image and the entry qualification information in the privilege information issuing apparatus 300 in advance in accordance with an operation of the user U1. Note that the user U1 may perform registration and the like of the user information using an information processing apparatus other than the user terminal 100. Furthermore, it is assumed that the user U1 enters the event venue 40 with the user terminal 100 carried with the user. Note that although the user U1 and the user terminal 100 are present inside the commercial facility 41 in FIG. 3, the location of presence is not limited thereto.

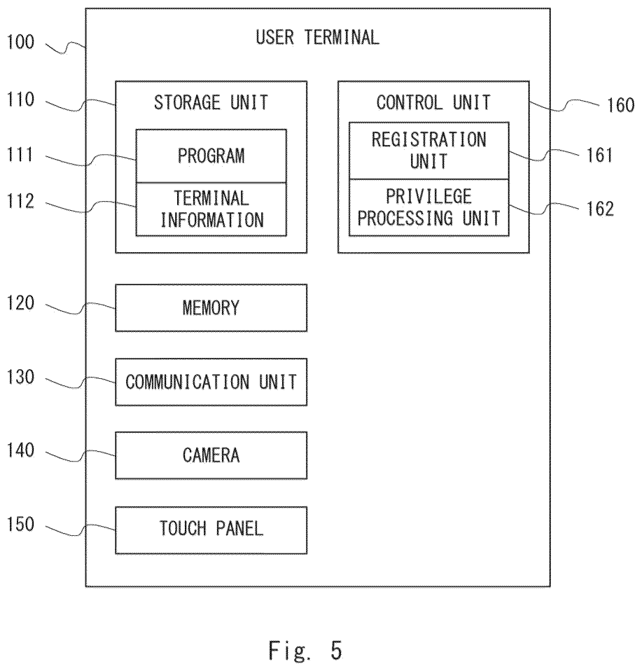

FIG. 5 is a block diagram illustrating a configuration of the user terminal 100 according to the second example embodiment. The user terminal 100 includes a storage unit 110, a memory 120, a communication unit 130, a camera 140, a touch panel 150, and a control unit 160. The storage unit 110 is an example of a nonvolatile storage device such as a flash memory. The storage unit 110 stores a program 111 and terminal information 112. The program 111 is a computer program in which processing such as registration of user information and entry qualification information, and inquiry, display, selection, and utilization of privilege information are mounted. The terminal information 112 is identification information and destination information of the user terminal 100.

The memory 120 is a volatile storage device such as a random access memory (RAM) and is a storage region for temporarily holding information during an operation of the control unit 160. The communication unit 130 is a communication interface with the network N.

The camera 140 is an imaging apparatus for imaging a region including the face of the user U1. The camera 140 outputs the captured image to the control unit 160. The touch panel 150 includes a display apparatus (display unit) such as a screen and an input apparatus.

The control unit 160 is a processor, that is, a control apparatus, that controls each configuration of the user terminal 100. The control unit 160 reads the program 111 from the storage unit 110 into the memory 120 and executes the program 111. In this manner, the control unit 160 implements the functions of the registration unit 161 and the privilege processing unit 162.

The registration unit 161 controls the camera 140, images the face of the user U1, and acquires the captured face image. Also, the registration unit 161 acquires attribute information and payment information input by the user U1 via the touch panel 150. In addition, the registration unit 161 reads and acquires the terminal information 112 from the storage unit 110. Then, the registration unit 161 transmits a registration request of the user information (member information) including the face image, the terminal information 112, the attribute information, and the payment information to the privilege information issuing apparatus 300. Furthermore, the registration unit 161 acquires entry qualification information purchased by the user U1. The registration unit 161 transmits a registration request including the face image of the user U1 and the entry qualification information to the privilege information issuing apparatus 300. Note that the registration unit 161 may include the entry qualification information in the registration request of the user information.

In a case where a privilege processing unit 162 receives a notification of privilege information issued by the privilege information issuing apparatus 300 at the time of face authentication payment at the commercial facility 41, the privilege processing unit 162 displays, on the touch panel 150, the privilege information provided through the notification. Furthermore, in a case where the payment has been made using the privilege information, the privilege processing unit 162 receives a payment completion and privilege information utilization notification and displays a payment result and a privilege information utilization result on the touch panel 150.

Also, the privilege processing unit 162 may perform the following processing. For example, the privilege processing unit 162 controls the camera 140 such that the face of the user U1 is imaged in response to a privilege issuing request provided through an instruction from the user U1 via the touch panel 150 and acquires the captured face image. At this time, the privilege processing unit 162 reads and acquires the terminal information 112 from the storage unit 110.

Then, the privilege processing unit 162 transmits a privilege issuing request including the face image and the terminal information 112 to the privilege information issuing apparatus 300. Also, in a case where the privilege processing unit 162 receives a notification of privilege information issued from the privilege information issuing apparatus 300, the privilege processing unit 162 displays the privilege information and the like provided through the notification on the touch panel 150. In addition, the privilege processing unit 162 transmits a privilege information inquiry request including the face image of the user U1 to the privilege information issuing apparatus 300 in response to the privilege inquiry request provided through an instruction from the user U1 via the touch panel 150. Then, the privilege processing unit 162 displays, on the touch panel 150, a list of the privilege information that has already been issued from the privilege information issuing apparatus 300 for the user U1. The privilege processing unit 162 displays the privilege information selected by the user U1 via the touch panel 150 in a selected state. In a case where the privilege processing unit 162 receives a privilege information update notification from the privilege information issuing apparatus 300, the privilege processing unit 162 displays the privilege information after update on the touch panel 150.

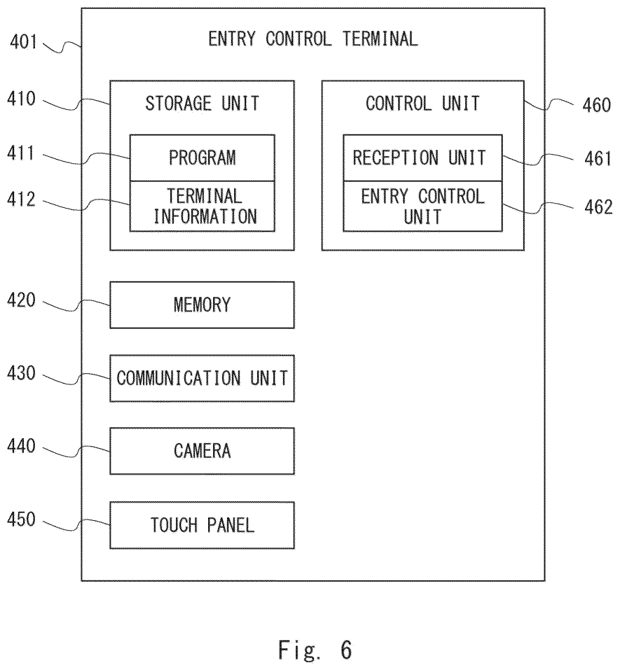

FIG. 6 is a block diagram illustrating a configuration of the entry control terminal 401 according to the second example embodiment. The entry control terminal 401 includes a storage unit 410, a memory 420, a communication unit 430, a camera 440, a touch panel 450, and a control unit 460. The storage unit 410 is an example of a nonvolatile storage device such as a flash memory. The storage unit 410 stores a program 411 and terminal information 412. The program 411 is a computer program in which the entry control processing and the like are mounted. The terminal information 412 is identification information and destination information of the entry control terminal 401.

The memory 420 is a volatile storage device such as a RAM, and is a storage region for temporarily holding information during operations of the control unit 460. The communication unit 430 is a communication interface with the network N.

The camera 440 is an imaging apparatus for imaging a region including a face of an entry scheduled person such as the user U1. The camera 440 outputs the captured image to the control unit 460. The touch panel 450 includes a display apparatus (display unit) such as a screen and an input apparatus.

The control unit 460 is a processor, that is, a control apparatus that controls each configuration of the entry control terminal 401. The control unit 460 reads the program 411 from the storage unit 410 into the memory 420 and executes the program 411. In this manner, the control unit 460 implements the functions of the reception unit 461 and the entry control unit 462.

The reception unit 461 receives the face image of the entry scheduled person captured by the camera 440 and outputs the face image to the entry control unit 462. The entry control unit 462 transmits an entry determination request including the face image output by the reception unit 461 and the terminal information 412 stored in the storage unit 110 to the privilege information issuing apparatus 300. Then, in a case where the entry control unit 462 receives an entry determination result from the privilege information issuing apparatus 300 and the entry determination result indicates permission of entry, the entry control unit 462 performs control to unlock an entrance gate (not illustrated) or the like of the event venue 40. Note that entry control terminal 401 may control an exit gate through face authentication at the time of exiting the site as well.

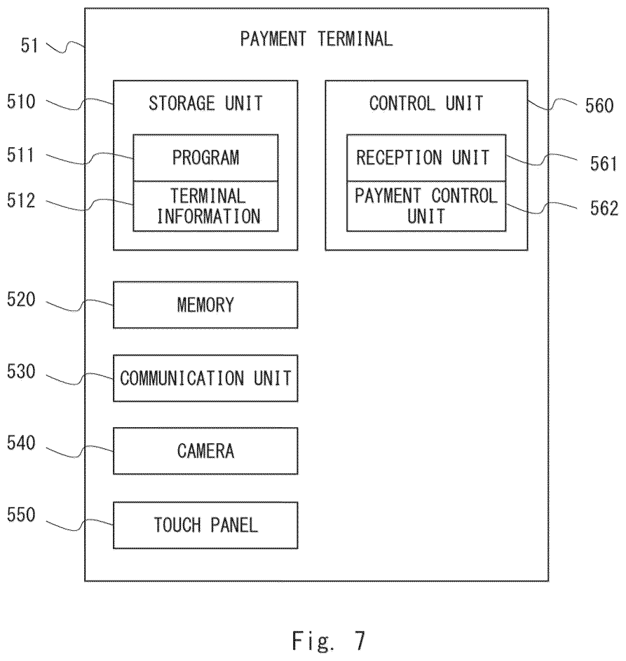

FIG. 7 is a block diagram illustrating a configuration of the payment terminal 51 according to the second example embodiment. Note that since the configurations of the payment terminal 5n and the like are similar to that of the payment terminal 51, illustration and detailed description will be omitted. The payment terminal 51 includes a storage unit 510, a memory 520, a communication unit 530, a camera 540, a touch panel 550, and a control unit 560. The storage unit 510 is an example of a nonvolatile storage device such as a flash memory. The storage unit 510 stores a program 511 and terminal information 512. The program 511 is a computer program in which payment control processing and the like are mounted. The terminal information 512 is identification information and destination information of the payment terminal 51. In addition, the terminal information 512 is assumed to be information with which the commercial facility 41 where the terminal is installed can be specified.

The memory 520 is a volatile storage device such as a RAM, and is a storage region for temporarily holding information during the operations of the control unit 560. The communication unit 530 is a communication interface with the network N.

The camera 540 is an imaging apparatus for imaging a region including a face of a person who makes payment such as the user U1. The camera 540 outputs the captured image to the control unit 560. The touch panel 550 includes a display apparatus (display unit) such as a screen and an input apparatus.

The control unit 560 is a processor, that is, a control apparatus that controls each configuration of the payment terminal 51. The control unit 560 reads the program 511 from the storage unit 510 into the memory 520 and executes the program 511. In this manner, the control unit 560 implements the functions of the reception unit 561 and the payment control unit 562.

The reception unit 561 receives an input of payment target information such as a price of a product for the person who makes payment will make a payment for. For example, the reception unit 561 receives, as payment target information, information read from a barcode on a product with a scanner (not illustrated) by a store staff (for example, the facility staff U21 or the like) of the commercial facility 41. Then, the reception unit 561 displays the received payment target information on the touch panel 550.

Subsequently, the payment control unit 562 controls the camera 540 to image the face of the person who has made payment and acquires the captured face image. Then, the payment control unit 562 transmits a face authentication payment request including the face image, the payment target information, and the terminal information 512 stored in the storage unit 510 to the privilege information issuing apparatus 300. Note that the payment target information may include a payment ID for identifying the payment processing. Then, the payment control unit 562 receives a payment completion notification or the like, and displays the payment completion notification or the like on the touch panel 550.

Also, the payment control unit 562 images code information of the privilege information displayed on the user terminal 100 with the camera 540, analyzes the captured image, and extracts a privilege ID. Subsequently, the payment control unit 562 controls the camera 540 to image the face of the person who has made payment and acquires the captured face image. Then, the payment control unit 562 transmits a face authentication payment request including the face image, the extracted privilege ID, the payment target information, and the terminal information 512 stored in the storage unit 510 to the privilege information issuing apparatus 300. Then, the payment control unit 562 receives a payment completion and privilege information utilization notification and displays a payment result and a privilege information utilization result on the touch panel 550.

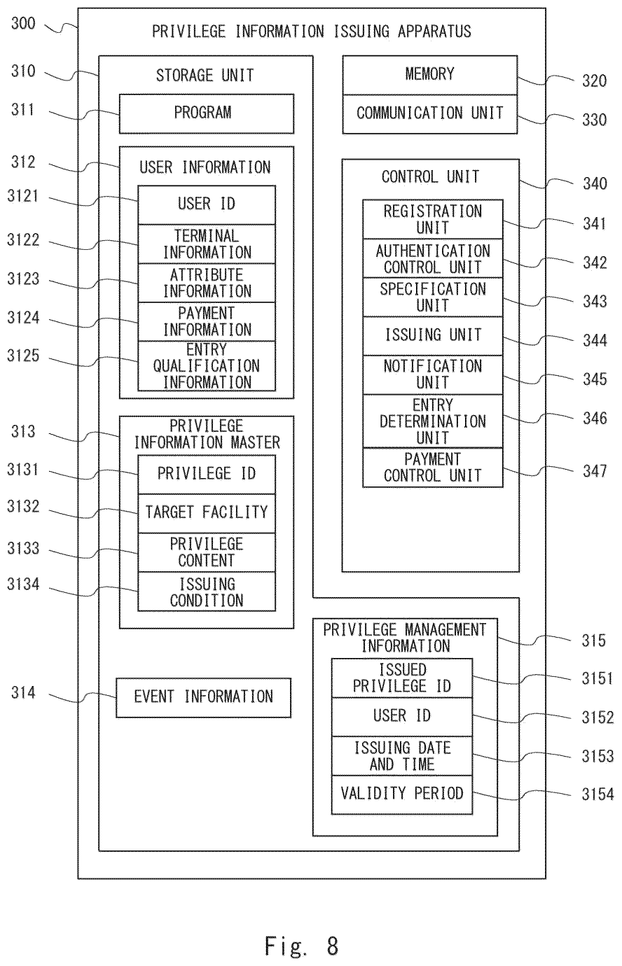

FIG. 8 is a block diagram illustrating a configuration of the privilege information issuing apparatus 300 according to the second example embodiment. The privilege information issuing apparatus 300 is an example of the aforementioned privilege information issuing apparatus 1. The privilege information issuing apparatus 300 is an information processing apparatus that performs payment processing at the commercial facility 41 or the like in response to a face authentication payment request from the payment terminal 51 or the like for the user who has the entry qualification information for the event venue 40. Also, the privilege information issuing apparatus 300 issues privilege information related to utilization of the event venue on the basis of the information that is attributable to the payment at the time of the face authentication payment. The privilege information issuing apparatus 300 may be made redundant across a plurality of serves, and each functional block may be implemented by a plurality of computers.

The privilege information issuing apparatus 300 includes a storage unit 310, a memory 320, a communication unit 330, and a control unit 340. The storage unit 310 is an example of a nonvolatile storage device such as a hard disk or a flash memory. The storage unit 310 stores a program 311, user information 312, a privilege information master 313, event information 314, and privilege management information 315. Note that the storage unit 310 and the face information DB 210 of the authentication apparatus 200 may be regarded as a storage apparatus that stores the entry qualification information, the identity authentication information of the user who has purchased the entry qualification information, and the terminal that the user carries with himself/herself in an associated manner. The program 311 is a computer program (privilege information issuing program) in which processing of registering the privilege information, the user information, and the entry qualification information, the privilege information issuing processing, the payment processing including the privilege information utilization processing, and the like according to the second example embodiment are implemented.

The user information 312 is information for managing users in the area 4. Note that “users in area 4” are, for example, purchasers of the entry qualification information of the event venue 40, entry scheduled persons who are scheduled to enter the event venue 40, entering persons, and persons exiting the event venue 40. The user information 312 is information in which a user ID 3121, terminal information 3122, attribute information 3123, payment information 3124, and entry qualification information 3125 are associated.

The user ID 3121 is identification information of the user. The user ID 3121 is information that is the same as or uniquely corresponds to the user ID 211 managed in association with the face feature information 212 in the face information DB 210 of the authentication apparatus 200. Therefore, it is possible to state that the user information 312 is information associated with the identity authentication information for registration of the user via the user ID 3121. The terminal information 3122 is information corresponding to the terminal information 112 of the user terminal 100 described above.

Examples of the attribute information 3123 include, but are not limited to, a name, a date of birth, a sex, an address, a contact (a telephone number, an e-mail address, account information of a social networking service (SNS)), a member rank, information indicating a hobby, preference, or interest, a support target of an athlete or a team, and the like. Note that the member rank may be, for example, information indicating a rank or the like in members who have made payment in the event venue 40, a rank in another member service, or the like.

The payment information 3124 is credit card information, electronic money, barcode payment account information, bank withdrawal account information, or the like, and is also information used for payment using face authentication (face authentication payment).

The entry qualification information 3125 is paid digital entry ticket information for a predetermined event held in the event venue 40 on a date and time of the event. The entry qualification information 3125 may include, for example, an event ID, seat information (a seat position and a seat grade), a ticket price, and the like. Furthermore, the entry qualification information 3125 may include identification information of the event venue, an entry time zone, an event content, and the like, instead of the event ID. Also, it is possible to state that the entry qualification information 3125 according to the present example embodiment is proof information indicating that the user has the qualification of permission to enter the event venue 40 on the basis of success in the face authentication.

Note that a purchase history of the entry qualification information 3125 in past events may be further registered in association with user ID 3121 in the user information 312.

The privilege information master 313 is information for managing master information of the privilege information input by facility staff or the area staff.

The privilege information master 313 is information in which a privilege ID 3131, a target facility 3132, a privilege content 3133, and an issuing condition 3134 are associated. The privilege ID 3131 is identification information of privilege information. The target facility 3132 is information indicating a facility where the privilege information can be used. The target facility 3132 is, for example, information indicating any of the commercial facilities 41 to 4n. Note that the target facility 3132 may be targeted to two or more facilities among the commercial facilities 41 to 4n.

The privilege content 3133 is information indicating a product or a service that the user can enjoy by being used in the facility. Examples of the privilege content 3133 include, but are not limited to, discount information indicating a discount price or a discount rate, a discount target product or service, a free product or service, and the like.

The issuing condition 3134 is information indicating a condition for issuing the privilege information. Examples of the issuing condition 3134 include event information (an event ID, date and time, and the like) to be issued, the fact that entry qualification information of the event information has already been purchased, and an issuing timing. The issuing timing is an issuing start date and time, an issuable period, or the like. In addition, examples of the issuing condition 3134 include, but are not limited to, attribute information of the user as a target of issuing, a seat grade, a ticket price, a priority order of attribute information prioritizing issuance, and the like.

The event information 314 is information defining an event held at the event venue 40. The event information 314 includes, for example, an event ID, a venue, event hour information, event contents, seat information (a seat type, a seat number, and arrangement), a price of the entry qualification information (ticket price), and the like. Note that examples of the event hour information include, but are not limited to, an event period, a start date and time, a scheduled start time, a scheduled end time, an entry time zone, an entry start time, and the like.

The privilege management information 315 is information for managing the privilege information issued for the user. The privilege management information 315 is information in which an issued privilege ID 3151, a user ID 3152, an issuing date and time 3153, and a validity period 3154 are associated.

The issued privilege ID 3151 is the privilege ID 3131 issued for the user corresponding to the user ID 3152. The user ID 3152 is the user ID 3121 for which the privilege information has been issued. Therefore, the privilege management information 315 is, for example, information uniquely specified by a set of the issued privilege ID 3151 and the user ID 3152. The issuing date and time 3153 is a date and time on which the privilege information has been issued. The validity period 3154 is a period in which the privilege according to the privilege information can be enjoyed (the privilege information is valid). The validity period 3154 is defined by a start date and time and an end date and time (effective period). In a case where the corresponding privilege information can be used immediately after the issuing, a date and time of the effective period may be set as the validity period 3154.

The memory 320 is a volatile storage device such as a RAM, and is a storage region for temporarily holding information during the operations of the control unit 340. The communication unit 330 is a communication interface with the network N.

The control unit 340 is a processor, that is, a control apparatus that controls each configuration of the privilege information issuing apparatus 300. The control unit 340 reads the program 311 from the storage unit 310 into the memory 320 and executes the program 311. Therefore, the control unit 340 implements functions of a registration unit 341, an authentication control unit 342, a specification unit 343, an issuing unit 344, a notification unit 345, an entry determination unit 346, and a payment control unit 347. Note that the authentication control unit 342 is an example of the authentication control unit 11 described above. The specification unit 343 and the issuing unit 344 are examples of the issuing unit 12 described above. Also, the specification unit 343 and the notification unit 345 are examples of the notification unit 13 described above.

The registration unit 341 performs registration processing and the like of the privilege information, the user information, and the entry qualification information. Specifically, the registration unit 341 receives a registration request of individual privilege information from the management terminal 61 or the like and registers the privilege information in the privilege information master 313. At this time, the registration unit 341 issues a privilege ID for the new privilege information. Furthermore, the registration unit 341 receives a registration request of the user information from the user terminal 100 or the like, and registers the registration request in the user information 312. At this time, the registration unit 341 registers face feature information based on a face image for a new user in the authentication apparatus 200, and acquires a user ID issued at the time of the registration. Then, the registration unit 341 registers the acquired user ID 3121 and the information (the terminal information, the attribute information, the payment information, and the like) included in the registration request in an associated manner as user information 312 in the storage unit 310. The registration unit 341 registers, in the storage unit 310, identity authentication information for registration of the user and terminal information possessed by the user in association with each other. The registration unit 341 according to the present example embodiment registers, in the storage unit 310, the user ID 3121 uniquely corresponding to the face feature information for registration of the user, the terminal information 3122, the attribute information 3123, and the payment information 3124 as the user information 312. Furthermore, the registration unit 341 receives a registration request including the face image and the entry qualification information, associates the entry qualification information 3125 with the user information 312 specified by the face authentication based on the face image, and updates the user information 312. Note that the registration unit 341 may associate the payment history of the user U1 inside the event venue 40 and in the commercial facility 41 and the like with the user ID 3121 and update the user information 312. The payment history may include a purchase history of the entry qualification information 3125 in the past events.

The authentication control unit 342 controls identity authentication of the user using the authentication apparatus 200. In particular, the authentication control unit 342 according to the present example embodiment controls biometric authentication of the user using biometric information extracted from an image obtained by imaging the user. Specifically, the authentication control unit 342 controls the face authentication of the user using the face feature information extracted from the face image of the user. In other words, in a case where the authentication control unit 342 receives the identity authentication information for authentication of the user and the entry qualification information, the authentication control unit controls the identity authentication with reference to the storage unit 310 and the face information DB 210 of the authentication apparatus 200 using the identity authentication information for authentication. In addition, in a case where the authentication control unit 342 receives a privilege issuing request including the face image or a privilege information inquiry request from the user terminal 100, the authentication control unit 342 transmits a face authentication request including the face image included in the request to the authentication apparatus 200 and receives a face authentication result from the authentication apparatus 200. Then, the authentication control unit 342 outputs the face authentication result to the specification unit 343 and the issuing unit 344. Also, in a case where the authentication control unit 342 receives an entry determination request from the entry control terminal 401, the authentication control unit 342 transmits a face authentication request including the face image included in the entry determination request to the authentication apparatus 200, receives a face authentication result from the authentication apparatus 200, and outputs the face authentication result to the entry determination unit 346. Also, in a case where the authentication control unit 342 receives a face authentication payment request from the payment terminal 51 or the like, the authentication control unit 342 transmits a face authentication request including the face image included in the face authentication payment request to the authentication apparatus 200, receives a face authentication result from the authentication apparatus 200, and outputs the face authentication result to the payment control unit 347. In other words, the authentication control unit 342 controls the identity authentication with reference to the face information DB 210 of the authentication apparatus 200 using the identity authentication information for authentication acquired from the user if the user makes a payment at a commercial facility (at a time of the payment by the user in the commercial facility) in the neighborhood of the event venue. Note that the authentication control unit 342 may control the identity authentication other than the biometric authentication.

The specification unit 343 specifies the terminal information, the attribute information, the payment information, the entry qualification information, and the privilege information of the user on the basis of the identity authentication for the user. Specifically, in a case where the face authentication performed by the authentication control unit 342 has been successful, the specification unit 343 specifies the user ID included in the face authentication result. Then, the specification unit 343 specifies the terminal information 3122, the attribute information 3123, the payment information 3124, and the entry qualification information 3125 associated with the specified user ID 3121 from the user information 312. Moreover, the specification unit 343 may specify corresponding event information 314 from the entry qualification information 3125. In particular, the specification unit 343 determines whether or not there is entry qualification information 3125 associated with the user ID 3121 of the user who has succeeded in the face authentication from the user information 312. In a case where it is determined that the entry qualification information is present, the specification unit 343 determines whether or not the entry qualification information 3125 satisfies a privilege information issuing condition. Specifically, the specification unit 343 determines whether or not event information as a target of issuing defined by the issuing condition 3134 includes the event corresponding to the entry qualification information determined to be present from the privilege information master 313. In a case where the event information as a target of issuing includes the entry qualification information associated with the user ID of the user who has succeeded in the face authentication, the specification unit 343 determines that the entry qualification information satisfies the privilege information issuing condition and specifies the entry qualification information.

Moreover, the specification unit 343 may specify seat information included in the specified entry qualification information 3125. Furthermore, the specification unit 343 may specify the purchase history of the entry qualification information of the events including the entry qualification information 3125 associated with the user ID 3121 of the user who has succeeded in the face authentication. Also, the specification unit 343 specifies a privilege ID included in the face authentication payment request and specifies the privilege information associated with the user ID 3152 of the user who has succeeded in the face authentication and the issued privilege ID 3151 from a privilege management information 315. In addition, the specification unit 343 specifies payment target information included in the face authentication payment request. In addition, the specification unit 343 specifies a list of privilege information associated with the user ID 3152 of the user who has succeeded in the face authentication from the privilege management information 315 in response to a privilege information inquiry request. Also, the specification unit 343 specifies the payment information 3124 associated with the user ID 3121 of the user who has succeeded in the face authentication from the user information 312.

In a case where the face authentication in response to the face authentication payment request has been successful, the issuing unit 344 issues the privilege information related to utilization of the event venue on the basis of the information that is attributable to the payment. For example, the issuing unit 344 issues privilege information including privilege content in accordance with the payment price. Alternatively, in a case where the type of the purchased product is an eco-related product, the issuing unit 344 issues privilege information. Note that the “eco-related product” is a product or the like manufactured using materials and the like that are regarded as being able to contribute to maintenance and protection of the global environment. Also, the issuing unit 344 issues the privilege information related to utilization of the event venue on the basis of the specified entry qualification information. In other words, in a case where the entry qualification information associated with the user ID of the user who has succeeded in the face authentication is specified as satisfying the privilege information issuing condition, the issuing unit 344 issues privilege information related to utilization of the event venue. Also, the issuing unit 344 may issue privilege information in accordance with specified seat information. In a case where the grade of the seat in the event venue 40 is high, for example, a privilege that is better than usual may be granted. Also, the issuing unit 344 may issue privilege information in accordance with the specified purchase history. Furthermore, the issuing unit 344 may issue the privilege information on the basis of the specified attribute information as well.

The notification unit 345 notifies the user terminal 100 of the user U1 of the privilege information issued by the issuing unit 344. In a case where the face authentication in response to the face authentication payment request has been successful, the entry qualification information has been acquired, and the privilege information has been issued, for example, the notification unit 345 specifies the terminal information 3122 associated with the user ID 3121. Then, the notification unit 345 notifies the user terminal 100 regarded as a destination from the specified terminal information 3122 of the privilege information. In addition, in a case where the payment control unit 347 completes the payment processing, the notification unit 345 transmits a payment completion notification to the payment terminal corresponding to the terminal information included in the face authentication payment request. In addition, in a case where the payment control unit 347 completes the payment processing using the privilege information, a payment completion and privilege information utilization notification is transmitted to the user terminal 100 of the user U1 and the payment terminal.

The entry determination unit 346 determines whether or not the face authentication result based on the entry determination request received from the entry control terminal 401 indicates that the face authentication has been successful, and transmits the entry determination result to the entry control terminal 401. The entry determination unit 346 includes an indication of permission of entry in the entry determination result in a case of the user who has succeeded in the face authentication and has entry qualification information registered, or the entry determination unit 346 includes an indication of non-permission of entry in the entry determination result in a case where the user has failed the face authentication. Note that, in a case where the face authentication has been successful, the entry determination unit 346 may perform registration in the user information 312 such that completion of entry of the user who has succeeded in the face authentication can be identified. For example, the entry determination unit 346 may register an entry state flag indicating “completion of entry” or the date and time of entry in the entry qualification information 3125 associated with the user ID 3121 of the user who has succeeded in the face authentication. Note that the entry determination unit 346 may update the entry state flag to “completion of exiting” in a case where exiting of the user is detected through face authentication or the like.

In a case where the face authentication based on the face authentication payment request received from the payment terminal 51 or the like has been successful, the payment control unit 347 controls the payment processing. Specifically, the payment control unit 347 performs the payment processing using the payment information 3124 associated with the user ID 3121 of the user who has succeeded in the face authentication. In particular, in a case where the privilege ID is included in the face authentication payment request, the payment control unit 347 determines whether or not the privilege information corresponding to the privilege ID can be used, and in a case where the privilege information can be used, the payment control unit 347 performs payment processing using the privilege information.

Specifically, in these cases, the payment control unit 347 specifies the facility from the terminal information included in the received face authentication payment request and specifies the target facility 3132 associated with the privilege ID (the issued privilege ID 3151, the privilege ID 3131) included in the face authentication payment request. In a case where the specified facility is included in the target facility 3132, the payment control unit 347 determines that the privilege information can be used. Furthermore, in a case where the utilization state flag and the like are included in the privilege management information 315, the payment control unit 347 may determine the availability in consideration of the utilization state flag and the like.

Then, in a case where the privilege information can be used, the payment control unit 347 specifies the payment information 3124 associated with the specified user ID 3121 from the user information 312. Then, the payment control unit 347 specifies the issued privilege ID 3151 associated with the specified user ID 3152 from the privilege management information 315 and specifies the privilege content 3133 associated with the issued privilege ID 3151 as the privilege ID 3131 from the privilege information master 313. Then, the payment control unit 347 applies the specified privilege content 3133 to the price of the payment target information included in the face authentication payment request and calculates a payment price. In a case where the privilege content 3133 is “lunch set 10% off”, for example, the payment control unit 347 calculates a price obtained by discounting 10% from the price of the payment target information as the payment price. Then, the payment control unit 347 transmits an instruction for withdrawing the payment price to a payment server (not illustrated) using the specified payment information 3124 and receives a payment result. Note that the payment server is a known server operated by a financial institution or the like and illustration and detailed description thereof will thus be omitted. Also, in a case where the privilege content 3133 is “one drink for free” and a drink is included in the payment target information, the payment control unit 347 subtracts the price of one glass of drink from the price of the payment target information and calculates the payment price.

On the other hand, in a case where the privilege information cannot be used, the payment control unit 347 performs the payment processing without using the privilege information. In other words, the payment control unit 347 performs the payment processing for the payment target information using the payment information of the specified user ID.

Here, a flow of registration of the privilege information will be described. Here, an example in which the facility staff U21 registers privilege information of the commercial facility 41 will be described. First, the management terminal 61 receives inputs of privilege content that can be used in the commercial facility 41, an issuing condition, and a target facility from the facility staff U21. The issuing conditions include event information that is a target of issuing. The target facility is the commercial facility 41. Then, the management terminal 61 transmits a privilege information master registration request including the received privilege content, issuing condition, and target facility to the privilege information issuing apparatus 300 via the network N. In response to the request, the privilege information issuing apparatus 300 issues the privilege ID corresponding to the privilege content included in the received privilege information master registration request and registers the issued privilege ID 3131, the target facility 3132 included in the request, the privilege content 3133, and the issuing condition 3134 in an associated manner as the privilege information master 313 in the storage unit 310. Similarly, the facility staff U2n registers privilege information related to the commercial facility 4n. Note that the area staff U3 may register the privilege information of the commercial facility 41 and the like using the management terminal 600. In addition, the facility staff U21 to U2n, the area staff U3, and the like may update the privilege content, the issuing conditions, and the target facilities in the privilege information that has already been registered.

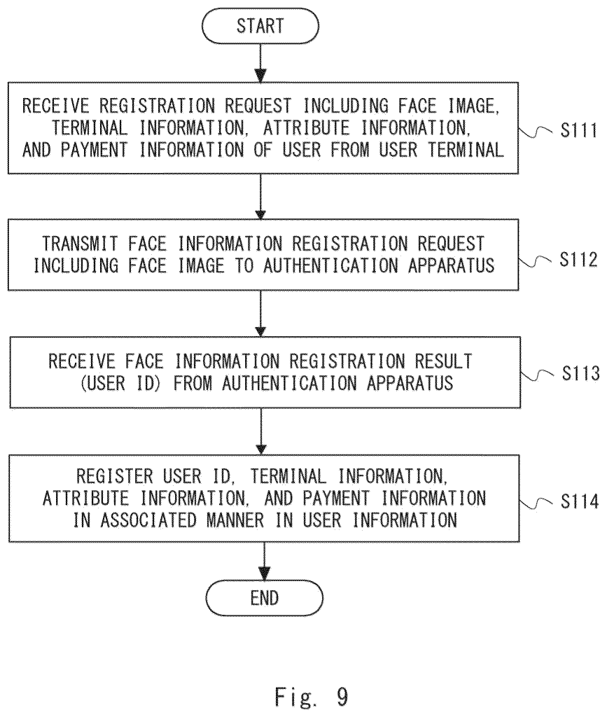

FIG. 9 is a flowchart illustrating a flow of member information registration processing according to the second example embodiment. First, the privilege information issuing apparatus 300 receives a registration request including a face image, terminal information, attribute information, and payment information of the user U1 from the user terminal 100 via the network N (S111). Then, the privilege information issuing apparatus 300 transmits a face information registration request including the face image to the authentication apparatus 200 via the network N (S112). In response to the transmission, the authentication apparatus 200 performs face information registration processing.

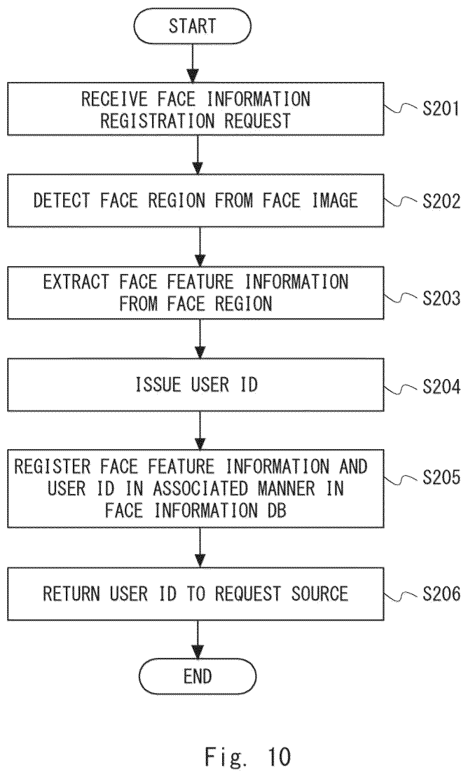

FIG. 10 is a flowchart illustrating a flow of face information registration processing performed by the authentication apparatus according to the second example embodiment. First, the authentication apparatus 200 receives the face information registration request (S201). For example, the authentication apparatus 200 receives the face information registration request from the privilege information issuing apparatus 300 via the network N. Then, the face detection unit 220 detects a face region from the face image included in the face information registration request (S202). Then, the feature point extraction unit 230 extracts feature points (face feature information) from the face region detected in Step S202 (S203). Then, the registration unit 240 issues the user ID 211 (S204). Then, the registration unit 240 registers the extracted face feature information 212 and the issued user ID 211 in an associated manner in the face information DB 210 (S205). Thereafter, the registration unit 240 returns the issued user ID 211 to the request source (for example, the privilege information issuing apparatus 300) (S206). Note that the authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 9, the description will be continued.

The privilege information issuing apparatus 300 receives a face information registration result (user ID) from the authentication apparatus 200 via the network N (S113). Then, the privilege information issuing apparatus 300 registers the received user ID 3121 and the terminal information 3122, the attribute information 3123, and the payment information 3124 received in Step S101 in an associated manner in the user information 312 (S114).

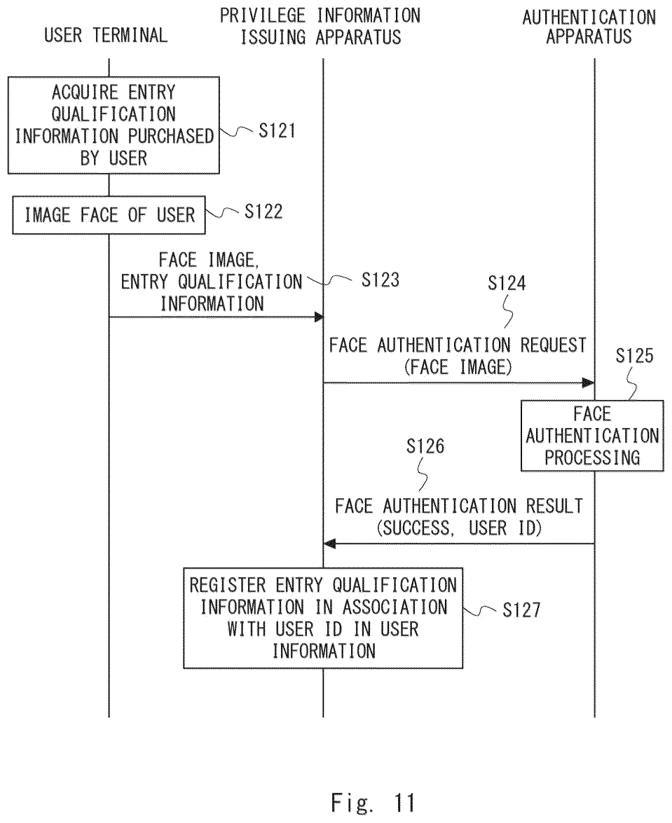

FIG. 11 is a sequence diagram illustrating a flow of entry qualification information registration processing according to the second example embodiment. As a premise, it is assumed that the user U1 has registered the user information in the privilege information issuing apparatus 300 and has purchased entry qualification information of an event held on a predetermined date at the event venue 40. At this time, the user terminal 100 acquires the entry qualification information purchased by the user U1 (S121). For example, the user terminal 100 may receive an input of identification information or the like of the entry qualification information from the user U1. Alternatively, the user terminal 100 may acquire information regarding the entry qualification information provided through a notification from a purchasing site of the entry qualification information. Then, the user terminal 100 images the face of the user U1 (S122). Then, the user terminal 100 transmits a registration request including the face image and the entry qualification information to the privilege information issuing apparatus 300 via the network N (S123).

Then, the privilege information issuing apparatus 300 transmits a face authentication request including the received face image to the authentication apparatus 200 via the network N (S124). In response to the transmission, the authentication apparatus 200 performs face authentication processing (S125).

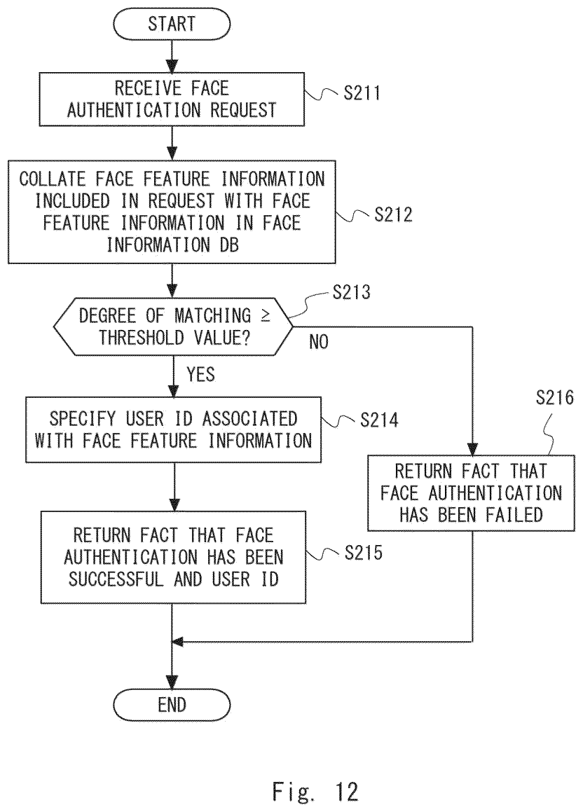

FIG. 12 is a flowchart illustrating a flow of face authentication processing performed by the authentication apparatus according to the second example embodiment. First, the authentication apparatus 200 receives a face authentication request from the privilege information issuing apparatus 300 via the network N (S211). Then, the authentication apparatus 200 extracts face feature information from the face image included in the face authentication request similarly to Steps S202 and S203 described above. Then, the authentication unit 250 of the authentication apparatus 200 collates the face feature information extracted from the face image included in the face authentication request with the face feature information 212 of the face information DB 210 (S212), and calculates a degree of matching. Then, the authentication unit 250 determines whether or not the degree of matching is equal to or greater than a threshold value (S213). In a case where the pieces of face feature information match each other, that is, in a case where the degree of matching between the pieces of face feature information is equal to or greater than the threshold value, the authentication unit 250 specifies the user ID 211 associated with the face feature information 212 (S214). Then, the authentication unit 250 returns a face authentication result, which includes information indicating that the face authentication has been successful and the specified user ID 211, to the privilege information issuing apparatus 300 via the network N (S215). In a case where the degree of matching is less than the threshold value in Step S213, the authentication unit 250 returns the face authentication result including information indicating that the face authentication has been failed to the privilege information issuing apparatus 300 via the network N (S216).

Returning to FIG. 11, the description will be continued.

The privilege information issuing apparatus 300 receives the face authentication result from the authentication apparatus 200 via the network N (S126). Then, the privilege information issuing apparatus 300 determines whether or not the face authentication has been successful. Specifically, the privilege information issuing apparatus 300 refers to the face authentication result and determines that the face authentication has been successful if the face authentication result includes the user ID. Note that in a case where it is determined that the face authentication has been failed, the privilege information issuing apparatus 300 may return the fact that the user has failed the face authentication to the user terminal 100 via the network N.

In a case where the face authentication has been successful, the privilege information issuing apparatus 300 associates the entry qualification information 3125 received in Step S123 with the user ID 3121 included in the face authentication result and registers them in the user information 312 (S127).

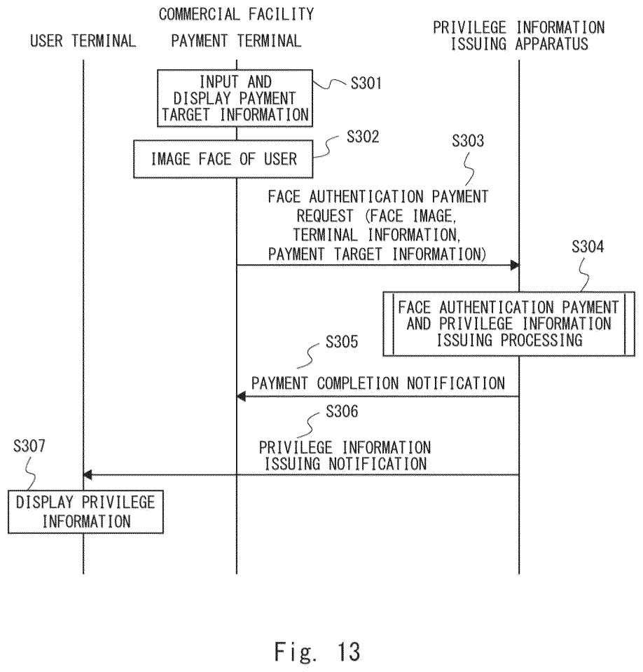

FIG. 13 is a sequence diagram illustrating a flow of face authentication payment and privilege information issuing processing according to the second example embodiment. As a premise, it is assumed that the member information registration processing in FIG. 9 and the entry qualification information registration processing in FIG. 11 described above have been completed for the user U1. In the following description, it is assumed that the user U1 visits the commercial facility 41.

First, the user U1 decides a product to be purchased at the commercial facility 41 and goes to the payment terminal 51 for payment. Then, the payment terminal 51 inputs and displays payment target information through scanning or the like of the product to be purchased and the touch panel 550 (S301). At this time, the payment terminal 51 may issue a payment ID for the input payment target information. Subsequently, the camera 540 of the payment terminal 51 images the face of the user U1 (S302). Then, the payment terminal 51 transmits a face authentication payment request including the face image of the user U1, the terminal information 512, and the payment target information including the payment ID to the privilege information issuing apparatus 300 via the network N (S303). Then, the privilege information issuing apparatus 300 performs face authentication payment and privilege information issuing processing (S304).

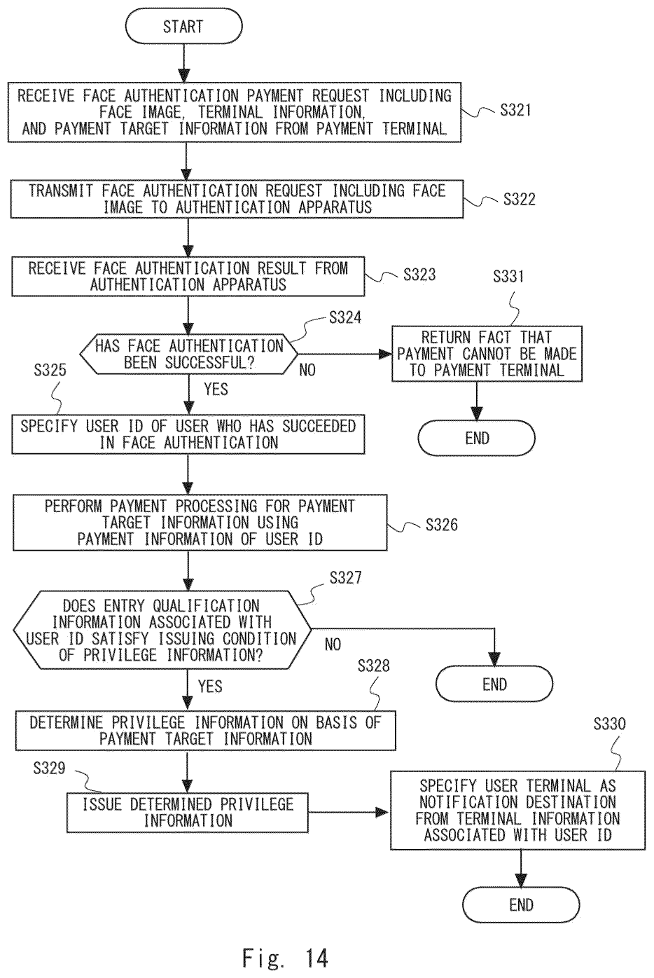

FIG. 14 is a flowchart illustrating a flow of face authentication payment and privilege information issuing processing according to the second example embodiment. First, the privilege information issuing apparatus 300 receives the face authentication payment request including the face image, the terminal information, and the payment target information from the payment terminal 51 via the network N (S321). Then, the privilege information issuing apparatus 300 transmits a face authentication request including the face image to the authentication apparatus 200 via the network N (S322). In response to this, the authentication apparatus 200 performs face authentication processing similarly to FIG. 12 described above. Then, the privilege information issuing apparatus 300 receives a face authentication result from the authentication apparatus 200 (S323). Then, the privilege information issuing apparatus 300 determines whether or not the face authentication has been successful (S324).

In a case where the face authentication has been successful, the privilege information issuing apparatus 300 specifies the user ID of the user who has succeeded in the face authentication (S325). Then, the privilege information issuing apparatus 300 performs the payment processing for payment target information using the payment information 3124 of the specified user ID 3121 (S326). For example, the privilege information issuing apparatus 300 specifies the payment information 3124 associated with the specified user ID 3121 from the user information 312. Then, the privilege information issuing apparatus 300 transmits, to a payment server (not illustrated), an instruction for withdrawing the price (payment price) of the payment target information included in the face authentication payment request using the specified payment information 3124 and receives a payment result.

Then, the privilege information issuing apparatus 300 determines whether or not the entry qualification information associated with the specified user ID satisfies the privilege information issuing condition (S327). Specifically, the privilege information issuing apparatus 300 determines whether or not the entry qualification information 3125 is associated with the specified user ID 3121 with reference to the user information 312. In a case where it is determined that the entry qualification information 3125 is associated with the specified user ID 3121, then the privilege information issuing apparatus 300 specifies event information 314 corresponding to the entry qualification information 3125. Then, the privilege information issuing apparatus 300 determines whether or not an event ID of the specified event information is defined by the issuing condition 3134 from the privilege information master 313. In a case where the event ID of the specified event information is defined by the issuing condition, the privilege information issuing apparatus 300 determines that the entry qualification information associated with the user ID of the user who has succeeded in the face authentication satisfies the privilege information issuing condition.

In a case where it is determined that the entry qualification information satisfies the issuing condition in Step S327, the privilege information issuing apparatus 300 determines privilege information on the basis of the payment target information (S328). In the present embodiment, the privilege information issuing apparatus 300 determines the privilege information related to utilization of the event venue 40 on the basis of the payment target information. Specifically, the privilege information issuing apparatus 300 specifies the payment price and the type of the purchased product or used service included in the payment target information. Also, the privilege information issuing apparatus 300 may determine to issue the privilege information related to utilization of the event venue 40 in a case where the specified payment price is equal to or greater than a predetermined price, for example. Alternatively, the privilege information issuing apparatus 300 may determine to issue the privilege information related to utilization of the event venue 40 in a case where the specified type of the purchased product is a specific product, for example, an eco-related product. Alternatively, the privilege information issuing apparatus 300 may determine to issue the privilege information related to utilization of the event venue 40 in a case where the specified type of the used service is a specific service at the commercial facility 41, for example, a specific food or drink menu. These lead to promotion of utilization of the specific product or service. Moreover, the privilege information issuing apparatus 300 may determine higher discount information than usual as the privilege information in a case where the specified payment price is equal to or greater than a specific price. Alternatively, the privilege information issuing apparatus 300 may determine privilege information that the user can upgrade the seat in the purchased entry qualification information in a case where the specified payment price is equal to or greater than a predetermined price. Specifically, the privilege information issuing apparatus 300 may refer to a latest seat sales status for a target event, detect an unoccupied seat as a target of the upgrading (A seat, for example), and determine a seat of the detected class as the privilege information. Alternatively, the privilege information issuing apparatus 300 may determine a present of a limited good at the event venue as the privilege information in a case where the specified type of the purchased product is an eco-related product. Alternatively, the privilege information issuing apparatus 300 may determine privilege information that a predetermined food menu at a store in the event venue 40 can be provided for free in a case where the specified type of the used service is a specific food or drink menu at the commercial facility 41. Note that the privilege information issuing apparatus 300 may determine a validity period of the privilege information on the basis of the payment target information.

Then, the privilege information issuing apparatus 300 issues the privilege information determined in Step S328 (S329). Specifically, the privilege information issuing apparatus 300 associates the privilege ID of the determined privilege information, the target facility (the event venue 40), and the privilege content as the issued privilege ID 3151, the target facility 3155, and the privilege content 3156 and generates the privilege management information 315. In addition, the privilege information issuing apparatus 300 sets the user ID specified in Step S325 as the user ID 3152, the current date and time as the issuing date and time 3153, and the determined validity period as the validity period 3154 in the generated privilege management information 315. The privilege information issuing apparatus 300 registers the generated and set privilege management information 315 in the storage unit 310. Additionally, the privilege information issuing apparatus 300 generates code information including the privilege ID of the issued privilege information.

Thereafter, the privilege information issuing apparatus 300 specifies the user terminal 100 as a notification destination from the terminal information 3122 associated with the user ID 3121 specified in Step S325 (S330). Note that in a case where the face authentication has been failed in Step S324, the privilege information issuing apparatus 300 returns the fact that payment cannot be made to the payment terminal 51 (S331). Moreover, in a case where it is determined that the entry qualification information does not satisfy the issuing condition in Step S327, the privilege information is not issued, and the processing is ended.

Returning to FIG. 13, the description will be continued. After Step S330, the privilege information issuing apparatus 300 transmits a payment completion notification to the payment terminal 51 via the network N (S305). In response to the transmission, the payment terminal 51 receives the payment completion notification and displays a payment result. Also, the privilege information issuing apparatus 300 transmits a privilege information utilization notification to the user terminal 100 of the user U1 via the network N (S306). In response to the transmission, the user terminal 100 receives the privilege information utilization notification and displays the privilege information (S307).

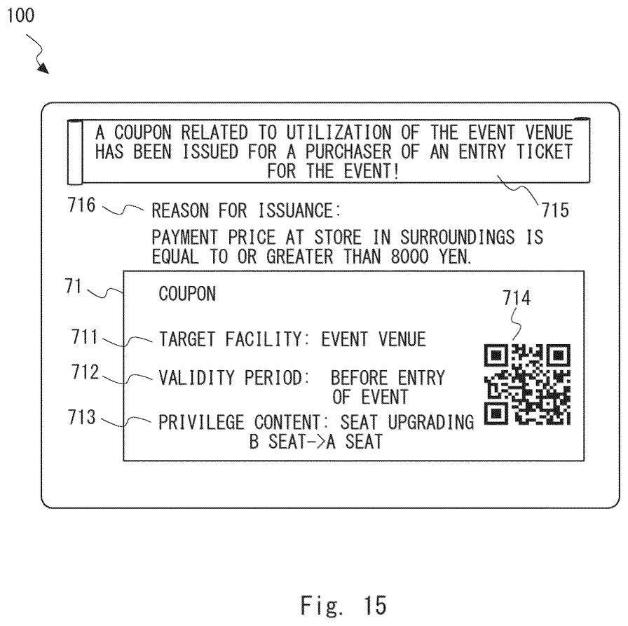

FIG. 15 is a diagram illustrating a display example of the issued privilege information according to the second example embodiment. A notification message 715 is text information included in the privilege information provided through the notification. The reason for issuance 716 is text information included in the privilege information provided through the notification and indicating a reason that the privilege information has been issued. Here, the notification message 715 indicates “A coupon related to utilization of the event venue has been issued for a purchaser of an entry ticket for the event!” Also, the reason for issuance 716 indicates that the payment price at a store in the surroundings is equal to or greater than 8000 yen. A coupon 71 displays a target facility 711, a validity period 712, privilege content 713, and code information 714. The target facility 711 indicates the event venue and the validity period 712 indicates “before entry for the event”. The privilege content 713 indicates that it is possible to upgrade the seat on the entry ticket for the event from the B seat to the A seat. The code information 714 is a two-dimensional code including the privilege ID. Note that the target facility 711, the validity period 712, the privilege content 713, the code information 714, the notification message 715, and the reason for issuance 716 are examples and are not limited thereto.

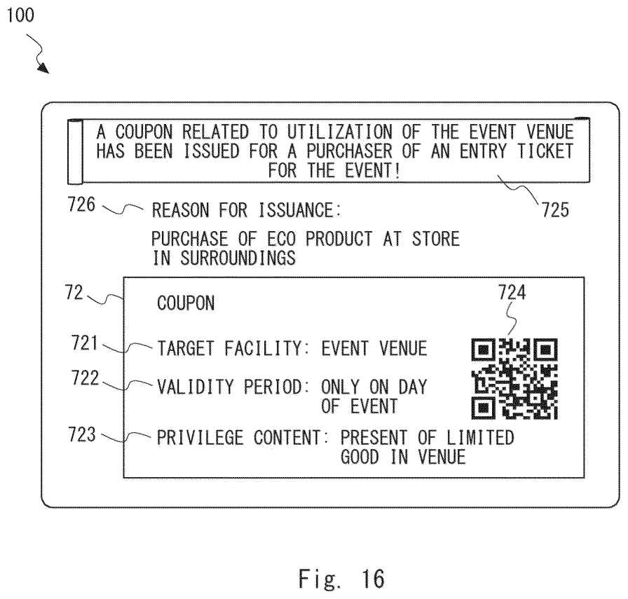

FIG. 16 is a diagram illustrating a display example of issued privilege information according to the second example embodiment. A notification message 725 is similar to the notification message 715 described above. There is an indication that the reason for issuance 726 is purchase of an eco product at a store in the surroundings. A coupon 72 displays a target facility 721, a validity period 722, privilege content 723, and code information 724. The target facility 721 is similar to the target facility 711 described above. The validity period 722 indicates “only the day of the event”. The privilege content 723 indicates that a present of a limited good will be given at the event venue, The code information 724 is a two-dimensional code including the privilege ID. Note that the target facility 721, the validity period 722, the privilege content 723, the code information 724, the notification message 725, and the reason for issuance 726 are examples and are not limited thereto.

In this manner, according to the present embodiment, the user who has the entry qualification information for the event held at the event venue can obtain the privilege information related to utilization of the event venue in accordance with the payment content at the time of the payment at the commercial facility in the surroundings. Specifically, the user can enjoy various privileges related to utilization of the event venue in the neighborhood of the commercial facility which is the location of the payment depending on how large the payment price is or whether the purchased product is an eco-related product. Therefore, it is possible to promote future purchase of entry qualification information and a consumption action at a commercial facility in the surroundings. Therefore, it is possible to contribute to cooperative utilization between the event venue and the commercial facility around the event venue and to make a contribution to activation of the region.

Note that in Step S328 in FIG. 14 described above, the privilege information issuing apparatus 300 may determine the privilege information on the basis of a purchase history of the user who has succeeded in the face authentication. In a case where the number of times the user has made purchase at the commercial facility is equal to or greater than a predetermined number of times, or in a case where the total purchase price is equal to or greater than a predetermined price, for example, a better privilege than usual may be granted. The privilege that is better than usual is, for example, a higher discount rate, a higher discount price, or a higher price of a free present. Alternatively, a privilege for initial utilization may be granted in a case where the entry qualification information is purchased for the first time or the payment at the commercial facility is made for the first time.

Note that the privilege information issuing apparatus 300 may present a plurality of candidates for privilege information to the user and allow the user to select one of them in a case where the privilege information issuing condition is satisfied. For example, the privilege information issuing apparatus 300 may set upgrading of a seat, a discount ticket for purchase at a store in the event venue, a present of an original good in the event venue, and the like as the candidates for the privilege information.

### Third Example Embodiment

A third example embodiment is a modified example of the second example embodiment described above. Information that is attributable to payment in the third example embodiment includes content of an action that has been made in relation to payment. Then, an issuing unit issues privilege information including privilege content in accordance with the content of the action. In particular, the content of the action includes an action related to global environment protection. Furthermore, an action related to global environment protection includes at least either utilization of public transportation or a bicycle to move to a commercial facility or non-utilization of a wrapping material in payment.

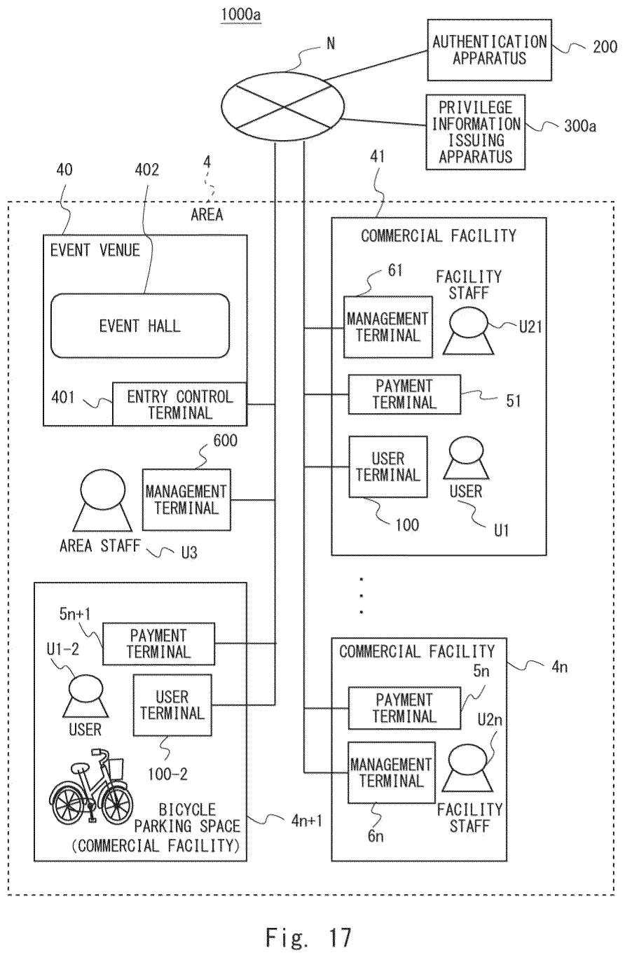

FIG. 17 is a block diagram illustrating an overall configuration of a privilege information issuing system 1000a according to the third example embodiment. As compared to FIG. 3 described above, a commercial facility 4n+1 is added in the area 4, and a privilege information issuing apparatus 300a is changed in the privilege information issuing system 1000a. Note that since the other configurations of the privilege information issuing system 1000a according to the third example embodiment are similar to those of the second example embodiment described above, repeated description and illustration will be omitted.

Similarly to the commercial facility 41 and the like described above, the commercial facility 4n+1 is a bicycle parking space which is an example of a facility in the surroundings or a commercial facility in the neighborhood of an event venue 40. A business operator of the bicycle parking space is a cooperative business operator with a business operator on the side of the event venue 40. In the commercial facility 4n+1, a payment terminal 5n+1 having a function similar to that of the payment terminal 51 described above is installed. In addition, an area staff U3 registers privilege information related to utilization of the event venue 40 using a management terminal 600 by regarding utilization (bicycle parking) of or payment (making a payment for a parking fee) at the commercial facility 4n+1 as an issuing condition. A user U1-2 is a purchaser or the like of entry qualification information of an event held in the event venue 40 who carries a user terminal 100-2 with himself/herself and operates the user terminal 100-2, travels to an area 4 by bicycle, and parks the bicycle at the bicycle parking space. The user U1-2 performs face authentication using the payment terminal 5n+1 at the time of parking the bicycle at the commercial facility 4n+1, at the time of payment of the parking fee, and at the time of registering a travel distance. Specifically, the payment terminal 5n+1 may transmit a bicycle parking registration request A including a face image of the user U1-2 and terminal information of the payment terminal 5n+1 to the privilege information issuing apparatus 300a if the user U1-2 parks the bicycle. Also, it is only necessary for the payment terminal 5n+1 to transmit a face authentication payment request B including the face image of the user U1-2 and the terminal information of the payment terminal 5n+1 to the privilege information issuing apparatus 300a at the time of the payment of the bicycle parking fee. Also, the payment terminal 5n+1 may acquire the travel distance by the bicycle from the user U1-2 or the user terminal 100-2 and transmit a travel distance registration request C including the face image of the user U1-2, the travel distance, and the terminal information of the payment terminal 5n+1 to the privilege information issuing apparatus 300a. Moreover, the user terminal 100-2 may acquire the travel distance of the user U1-2 by the bicycle and transmit a travel distance registration request D including the face image of the user U1-2, the travel distance, and the terminal information of the commercial facility 4n+1 to the privilege information issuing apparatus 300a. Note that each of the payment terminal 5n+1 and the user terminal 100-2 is connected to the network N.

The privilege information issuing apparatus 300a receives the bicycle parking registration request A described above from the payment terminal 5n+1 and specifies utilization of the bicycle as content of the action of the user who has succeeded in the face authentication. In addition, the privilege information issuing apparatus 300a receives the face authentication payment request B at the time of the payment of the bicycle parking fee from the payment terminal 5n+1, performs payment of the bicycle parking fee using payment information of the user who has succeeded in the face authentication, and also specifies utilization of the bicycle as content of the action of the user. Also, the privilege information issuing apparatus 300a receives the travel distance registration request C or D described above from the payment terminal 5n+1 or the user terminal 100-2 and specifies the travel distance of the bicycle as content of the action of the user who has succeeded in the face authentication. In these cases, the privilege information issuing apparatus 300a registers the specified content of the action in association with a user ID. In addition, the privilege information issuing apparatus 300a issues privilege information on the basis of the content of the action of the user who has succeeded in the face authentication. Specifically, in a case where the content of the action is utilization of the bicycle, or in a case where the travel distance of the bicycle is equal to or greater than a predetermined distance, the privilege information issuing apparatus 300a regards the case as corresponding to an eco-friendly activity and issues privilege information related to utilization of the event venue 40. Furthermore, the privilege information issuing apparatus 300a may change the privilege content in accordance with the travel distance of the bicycle. Specifically, the privilege information issuing apparatus 300a may increase a discount rate or a discount price of the privilege content or may allow exchange with a more expensive product or a product with a higher rarity value as the travel distance increases.

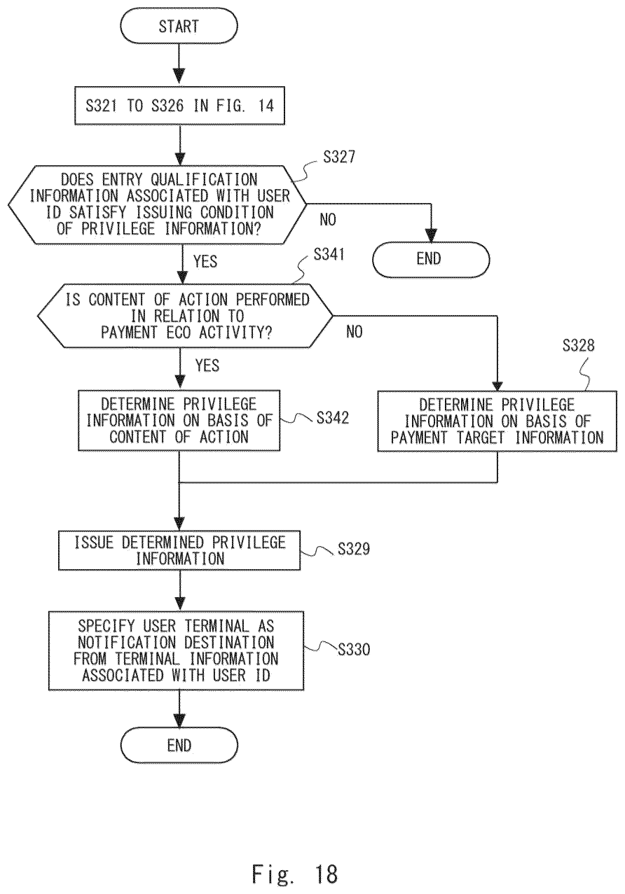

FIG. 18 is a flowchart illustrating a flow of face authentication payment and privilege information issuing processing according to the third example embodiment. First, the privilege information issuing apparatus 300a receives the face authentication payment request B including the face image, the terminal information, and payment target information (bicycle parking fee) from the payment terminal 5n+1 via a network N (S321). Then, the privilege information issuing apparatus 300a executes Steps S322 to S325 in FIG. 14 described above. Then, the privilege information issuing apparatus 300a performs payment processing for the bicycle parking fee using the payment information of the user U1-2 (S326).

Thereafter, the privilege information issuing apparatus 300a determines whether or not entry qualification information associated with the specified user ID satisfies a privilege information issuing condition (S327). In a case where it is determined that the entry qualification information satisfies the issuing condition in Step S327, the privilege information issuing apparatus 300a determines whether or not the content of action performed in relation to the payment is an eco-friendly activity (S341). Here, since the content of the action performed in relation to the payment on the basis of the face authentication payment request B is utilization of the bicycle, the privilege information issuing apparatus 300a determines that the action corresponds to an eco-friendly activity which is an activity related to global environment protection. Also, it is assumed that the privilege information issuing apparatus 300a has received the bicycle parking registration request A from the payment terminal 5n+1 before the face authentication payment request B and the utilization of the bicycle has been registered as the content of the action. The privilege information issuing apparatus 300a determines that the content of the action performed in relation to the payment corresponds to an eco-friendly activity in this case as well.

Alternatively, it is assumed that the privilege information issuing apparatus 300a has received the travel distance registration request C from the payment terminal 5n+1 or has received the travel distance registration request D from the user terminal 100-2 before the face authentication payment request B and the travel distance of the bicycle has been registered as the content of the action. Even in a case where the travel distance of the bicycle included in the content of the action associated with the user who has succeeded in the face authentication is equal to or greater than a predetermined distance, the privilege information issuing apparatus 300a determines that the content of the action corresponds to an eco-friendly activity.

In a case where it is determined that the content of the action performed in relation to the payment in Step S341 is an eco-friendly activity, the privilege information issuing apparatus 300a determines privilege information on the basis of the content of the action (S342). In a case where the content of the action is utilization of the bicycle, or in a case where the travel distance of the bicycle is equal to or greater than the predetermined distance, for example, the privilege information issuing apparatus 300a may determine discounting from a purchase price of entry qualification information for the next event as privilege information.

On the other hand, in a case where the content of the action performed in relation to the payment in Step S341 is not an eco-friendly activity, the privilege information issuing apparatus 300a determines privilege information on the basis of the payment target information similarly to Step S328 in FIG. 14 described above.

After Step S342 or S328, the privilege information issuing apparatus 300a issues the determined privilege information and specifies the user terminal 100 as a notification destination from the terminal information 3122 similarly to Steps S329 and S330 in FIG. 14 described above. Thereafter, the privilege information issuing apparatus 300a transmits a payment completion notification to the payment terminal 51 via the network N (S305), and the payment terminal 51 receives the payment completion notification and displays a payment result. Also, the privilege information issuing apparatus 300a transmits a privilege information utilization notification to the user terminal 100-2 of the user U1-2 via the network N (S306). In response to the transmission, the user terminal 100-2 receives the privilege information utilization notification and displays the privilege information (S307).

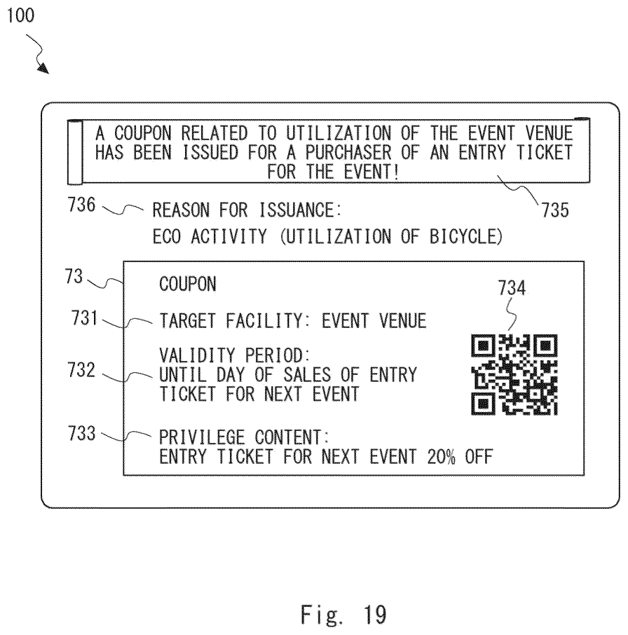

FIG. 19 is a diagram illustrating a display example of issued privilege information according to the third example embodiment. A notification message 735 is similar to the notification message 715 described above. A reason for issuance 736 indicates an eco-friendly activity (utilization of the bicycle). A coupon 73 displays a target facility 731, a validity period 732, privilege content 733, and code information 734. The target facility 731 is similar to the target facility 711 described above. The validity period 732 indicates “until a sales day of an entry ticket for the next event”. The privilege content 733 indicates an entry ticket 20% off for the next event. The code information 734 is a two-dimensional code including a privilege ID. Note that the target facility 731, the validity period 732, the privilege content 733, the code information 734, the notification message 735, and the reason for issuance 736 are examples and are not limited thereto.

Note that the eco-friendly activity is not limited to the utilization of the bicycle and may be utilization of public transportation (a bus or a railway) to travel to a commercial facility or non-utilization of a wrapping material (a so-called plastic bag) at the payment. In the case of utilization of public transportation, the commercial facility 4n+1 is a railway station, a bus stop, or the like, and it is only necessary for the payment terminal 5n+1 to be a ticket gate at a station or the like. Also, in the case of non-utilization of a plastic bag, it is only necessary for the payment terminal 51 to include the non-utilization of a plastic bag in the face authentication payment request and transmit the face authentication payment request to the privilege information issuing apparatus 300a. In this case, the privilege information issuing apparatus 300a specifies the non-utilization of a plastic bag as content of the action performed in relation to the payment from the face authentication payment request after the payment processing in Step S326 and determines that the non-utilization of a plastic bag corresponds to an eco-friendly activity in Step SS341.

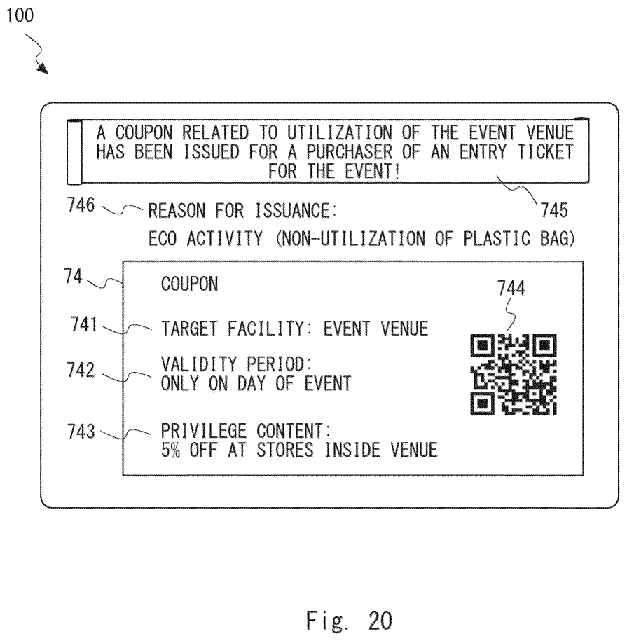

FIG. 20 is a diagram illustrating a display example of issued privilege information according to the third example embodiment. A notification message 745 is similar to the notification message 715 described above. A reason for issuance 746 indicates an eco-friendly activity (non-utilization of a plastic bag). A coupon 74 displays a target facility 741, a validity period 742, privilege content 743, and code information 744. The target facility 741 is similar to the target facility 711 described above. The validity period 742 indicates “only the day of the event”. The privilege content 743 indicates 5% off at a store in the event venue 40. The code information 744 is a two-dimensional code including the privilege ID. Note that the target facility 741, the validity period 742, the privilege content 743, the code information 744, the notification message 745, and the reason for issuance 746 are examples and are not limited thereto.

In this manner, privilege information related to utilization of the event venue is issued on the basis of content of the action performed in relation to the payment, rather than the payment itself, as information that is attributable to the payment at the commercial facility in the present embodiment. In this manner, various actions in relation to the payment at the facility around the event venue are targets of privilege granting at the event venue. It is thus possible to promote mutual utilization of the event venue and the facilities in the surroundings. According to the example embodiment, it is possible to enjoy the privilege in a case where an action (eco-friendly activity) related to global environment protection is performed in relation to the payment at the facility around the event venue, in particular. It is thus possible to contribute to global environment protection as well.

Note that a utilization history of electronic money that can be used to make a payment for a public transportation may be used as a way of detecting utilization of public transportation to travel to the area including the event venue and the commercial facility. For example, the privilege information issuing apparatus may associate an ID of the electronic money with the user ID and acquire a utilization history corresponding to the ID of the electronic money from a utilization management server of the electronic money at a predetermined timing. Then, in a case where utilization of public transportation to travel to the area is detected on the basis of the acquired utilization history, the privilege information issuing apparatus may issue privilege information and provide a notification to the user.

### Fourth example embodiment

A fourth example embodiment is a modified example of the second or third example embodiment described above. In the fourth example embodiment, privilege information is assumed to be so-called “points”, which are an example of electronic added value information. Also, a case where the points can be used for another privilege related to utilization of an event venue 40, exchange with products that can be purchased at the event venue 40, or services provided at the event venue 40 will be described. Note that since an overall configuration of a privilege information issuing system according to the fourth example embodiment is similar to that in the second or third example embodiment described above, repeated description and illustration will be omitted.

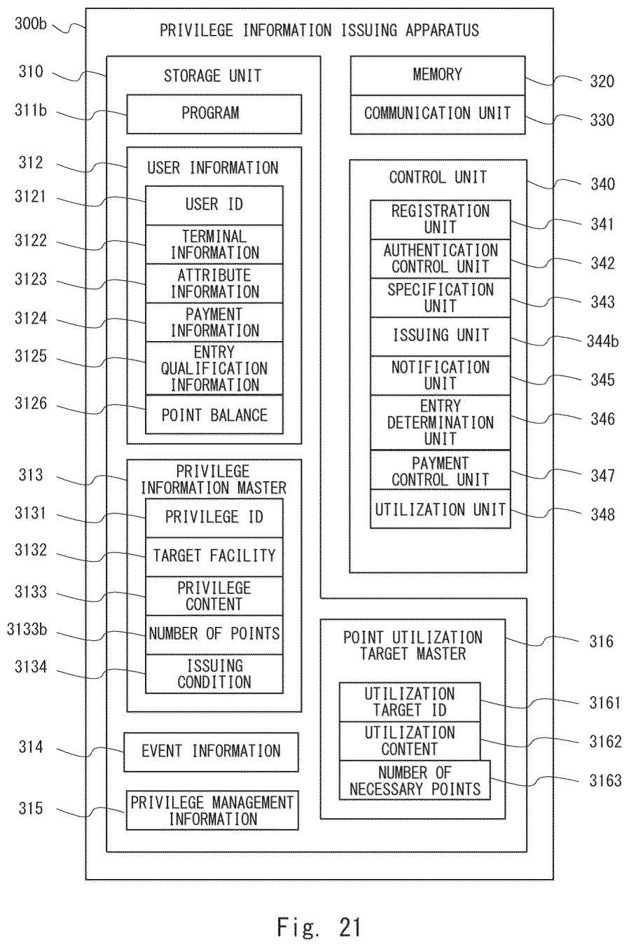

FIG. 21 is a block diagram illustrating a configuration of a privilege information issuing apparatus 300b according to the fourth example embodiment. As compared with FIG. 8 described above, a program 311b and an issuing unit 344b are changed, a point balance 3126 in user information 312, the number of points 3133b in a privilege information master 313, a point utilization target master 316, and a utilization unit 348 are added to the privilege information issuing apparatus 300b.

The program 311b is a computer program (privilege information issuing program) which implements processing and the like according to the fourth example embodiment in addition to the processing of the program 311 described above. The point balance 3126 is a balance of the number of points associated with a user ID 3121 as privilege information issued for a corresponding user. The point balance 3126 is added if the privilege information is issued and is subtracted if the privilege information is used (exchanged).

The number of points 3133b is the number of points associated with a privilege ID 3131 as a target of issuing in corresponding privilege information. Note that the number of points 3133b may be included in privilege content 3133.

A point utilization target master 316 is information that manages master data regarding products, services, and the like that are targets of utilization of the point balance 3126. The point utilization target master 316 is information with which a utilization target ID 3161, utilization content 3162, and the number of necessary points 3163 are associated. The utilization target ID 3161 is identification information of the target of utilization of the points. The utilization content 3162 is content of the target of utilization of the points. The utilization content 3162 is, for example, a discount coupon that can be used in a store in the event venue 40, a limited good that can be gotten in the event venue 40, an entry ticket for the next event, exchange with other points, or the like. The number of necessary points 3163 is the number of points necessary to use or exchange the corresponding utilization content 3162.

The issuing unit 344b determines the number of points that can be used to make a payment related to utilization of the event venue on the basis of information that is attributable to payment. Then, the issuing unit 344b issues privilege information by adding the determined number of points to the point balance 3126 of the user. The utilization unit 348 uses points designated by a user from the point balance 3126 for another privilege (utilization target) in the event venue 40.

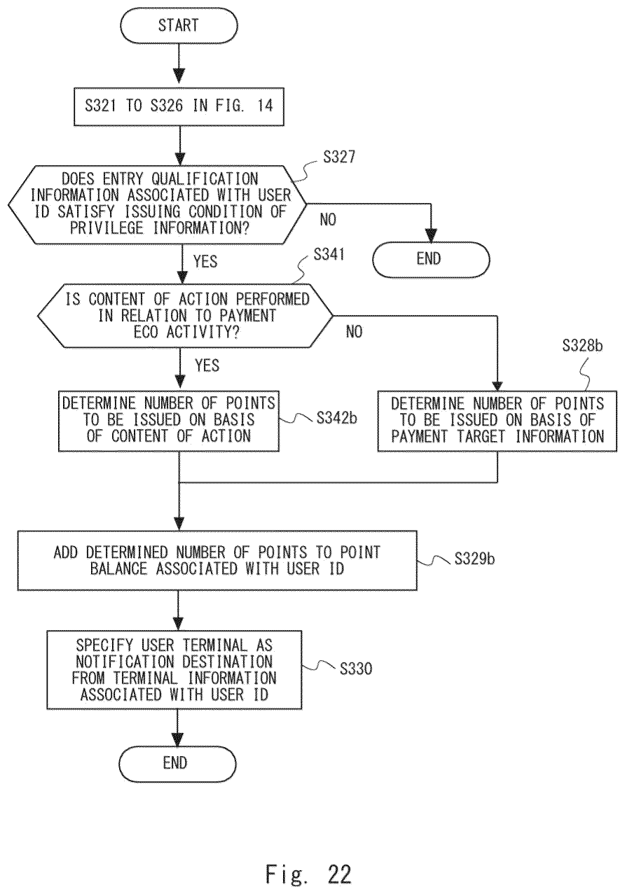

FIG. 22 is a flowchart illustrating a flow of face authentication payment and privilege information issuing processing according to the fourth example embodiment. First, the privilege information issuing apparatus 300b executes Steps S321 to S326 in FIG. 14 described above and determines that entry qualification information satisfies the issuing condition in S327. Then, the privilege information issuing apparatus 300b determines whether or not content of the action performed in relation to the payment is an eco-friendly activity similarly to Step S341 in FIG. 18 described above.

In a case where it is determined that the content of the action performed in relation to the payment in Step S341 is an eco-friendly activity, the privilege information issuing apparatus 300b determines the number of points to be issued on the basis of the content of the action (S342b). Specifically, the privilege information issuing apparatus 300b specifies a privilege ID 3131, the action content of which has been defined in an issuing condition 3134, from the privilege information master 313 and specifies the number of points 3133b associated with the specified privilege ID 3131. Note that the privilege information issuing apparatus 300b may determine the number of points to be issued on the basis of the content of the action and the payment target information in Step S342b.

Also, in a case where it is determined that the content of the action performed in relation to the payment in Step S341 is not an eco-friendly activity, the privilege information issuing apparatus 300b determines the number of points to be issued on the basis of the payment target information (S328b). Specifically, the privilege information issuing apparatus 300b specifies the privilege ID 3131 for which the price of the payment target information, the type of the purchased product, or the like has been defined in the issuing condition 3134 from the privilege information master 313 and specifies the number of points 3133b associated with the specified privilege ID 3131.

After Step S342b or S328b, the privilege information issuing apparatus 300b adds the determined number of points to the point balance 3126 associated with the user ID 3121 specified in Step S325 (S329b). Thereafter, the privilege information issuing apparatus 300b specifies the user terminal 100 as a notification destination from the terminal information 3122 similarly to Step S330 in FIG. 14 described above. Thereafter, the privilege information issuing apparatus 300b transmits a payment completion notification to the payment terminal 51 via the network N (S305), and the payment terminal 51 receives the payment completion notification and displays a payment result. Also, the privilege information issuing apparatus 300b transmits a privilege information utilization notification to the user terminal 100 of the user U1 via the network N (S306). In response to the transmission, the user terminal 100 receives the privilege information utilization notification and displays the privilege information (the number of points to be issued, the point balance, and the like) (S307).

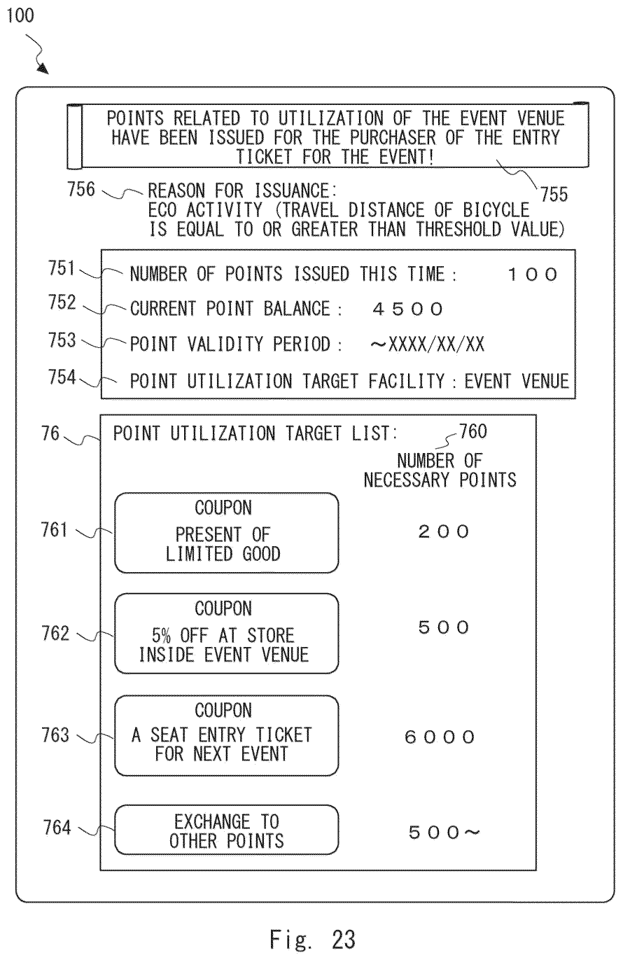

FIG. 23 is a diagram illustrating a display example of issued privilege information according to the fourth example embodiment. A notification message 755 indicates “Points related to utilization of the event venue have been issued for the purchaser of the entry ticket for the event!” A reason for issuance 756 indicates an eco-friendly activity (the travel distance of the bicycle is equal to or greater than a threshold value). The number of points to be issued 751 indicates that 100 points have been issued since the travel distance of the bicycle is equal to or greater than the threshold value. A point balance 752 indicates that the current point balance is 4500 points. A validity period 753 indicates an effective period of the points. A target facility 754 indicates that the facility where the points can be used is the event venue 40.

A point utilization target list 76 indicates that the number of necessary points for each utilization target is 760. A coupon 761 indicates a present of a limited good and indicates that 200 points are needed for utilization. A coupon 762 indicates a present of a limited good and indicates that the number of necessary points is 200 points. The coupon 762 indicates 5% off at a store in the event venue and indicates that the number of necessary points is 500 points. A coupon 763 indicates an entry ticket (A seat) for the next event and indicates that the number of necessary points is 6000 points. Exchange 764 with other points indicates that 500 points or more are needed to exchange to points for another point service that can be used for a consumption action at the event venue 40.

Thereafter, once the user U1 selects any one of the coupons 761 to 763 and the exchange 764 to other points, the user terminal 100 transmits a utilization request including the face image of the user U1, the coupon ID (privilege ID) or the like, and designation of the number of points to the privilege information issuing apparatus 300b via the network N. In response to the transmission, the privilege information issuing apparatus 300b performs face authentication on the basis of the face image included in the received utilization request, and in a case where the face authentication is successful, the privilege information issuing apparatus 300b performs point utilization processing. In a case where the coupon 761 is designated, for example, the privilege information issuing apparatus 300b issues privilege information corresponding to the coupon 761 and subtracts 200 points from the point balance 3126 of the user U1. Also, in a case where the exchange 764 to other points and the number of points to be exchanged are designated, the privilege information issuing apparatus 300b subtracts the number of points to be exchanged from the point balance 3126 of the user U1 and transmits an addition request corresponding to the number of points to be exchanged to another point service. In this manner, the privilege information issuing apparatus 300b can use the points designated by the user from the point balance 3126 for another privilege (utilization target) at the event venue 40.

As described above, according to the example embodiment, it is possible to issue the points on the basis of the information that is attributable to the payment at the commercial facility in the neighborhood of the event venue after the purchase of the entry qualification information for the event venue and to use the cumulative value of the points for another privilege that can be used at the event venue 40. Therefore, it is possible to motivate the user to continuously perform the purchase of the entry qualification information and the payment at the commercial facility in the neighborhood. Therefore, it is possible to promote mutual utilization of the event venue and the facility in the surroundings according to the example embodiment as well.

### Other Example Embodiments

Note that as described above, the “information that is attributable to the payment” includes whether or not there is privilege information used in the payment. In a case where the payer has succeeded in the identity authentication in the payment made at the commercial facility in the neighborhood of the event venue and predetermined privilege information has been used, for example, the privilege information issuing apparatus may issue other privilege information and notify the user who is the payer of the issued privilege information. In a case where the coupon has been used in a commercial facility in the neighborhood of the event venue, for example, a coupon that can be used in the event venue may be issued. In this manner, it is possible to further promote mutual utilization of the event venue and the facilities in the surroundings in the area.

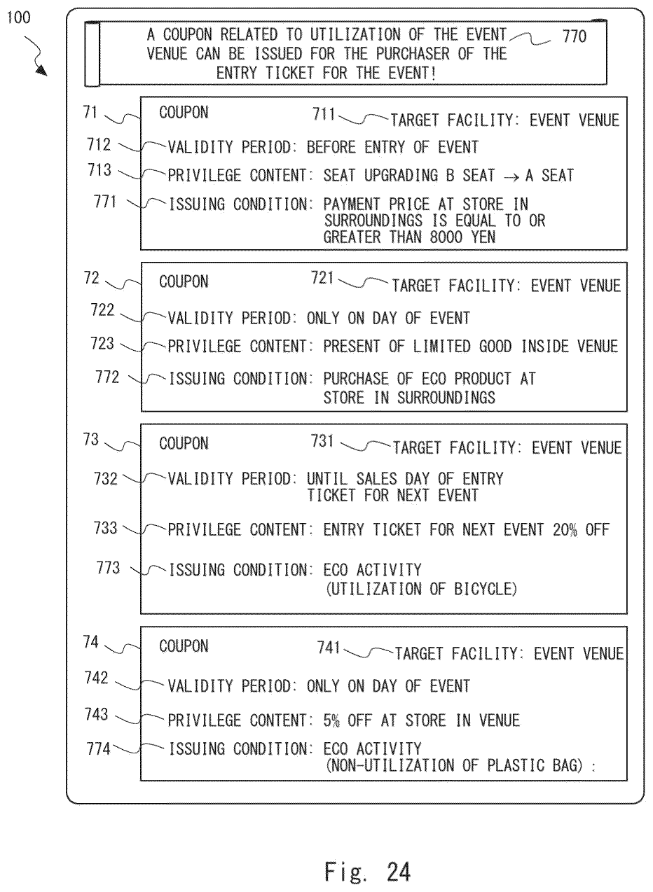

Note that the privilege information issuing apparatus may notify the user terminal of the issuing condition of the privilege information in response to a request from the user, periodically, or at a predetermined timing. Specifically, it is only necessary for the privilege information issuing apparatus to notify the user of the issuing condition of the privilege information and the privilege content before the user makes a payment at the commercial facility in the neighborhood of the event venue. Moreover, the privilege information issuing apparatus may notify the user terminal of the privilege information and the issuing condition thereof instead of issuing the privilege information at the time of the face authentication payment request. FIG. 24 is a diagram illustrating a display example of the issuing condition of the privilege information. A notification message 770 is text information included in information provided through a notification. Here, the notification message 770 indicates “A coupon related to utilization of the event venue can be issued for the purchaser of the entry ticket for the event!” Each of coupons 71 to 74 indicates a coupon that can be issued. The coupon 71 includes an issuing condition 771 in addition to the target facility 711, the validity period 712, and the privilege content 713 described above. The issuing condition 771 indicates that the issuing condition for the coupon 71 is that the payment price at the store in the surrounding is equal to or greater than 8000 yen. The coupon 72 includes an issuing condition 772 in addition to the target facility 721, the validity period 722, and the privilege content 723 described above. The issuing condition 772 indicates that the issuing condition of the coupon 72 is purchase of an eco product at the store in the surroundings. The coupon 73 includes an issuing condition 773 in addition to the target facility 731, the validity period 732, and the privilege content 733 described above. The issuing condition 773 indicates that the issuing condition of the coupon 73 is an eco-friendly activity (utilization of a bicycle). The coupon 74 includes an issuing condition 774 in addition to the target facility 741, the validity period 742, and the privilege content 743 described above. The issuing condition 774 indicates that the issuing condition of the coupon 74 is an eco-friendly activity (non-utilization of a plastic bag). Note that the notification message 770, the coupons 71 to 74, and particularly, the issuing conditions 771 to 774 are examples and are not limited thereto. In this manner, the user can recognize in advance that the privilege information can be obtained by purchasing the entry qualification information and making a payment at the commercial facility in the neighborhood of the event venue. Therefore, the user is further motivated to carry out a purchase activity or an eco-friendly activity to satisfy the issuing condition of the privilege information.

Furthermore, the privilege information issuing apparatus may issue and provide a notification of the privilege information for the user who has entry qualification information of a specific event or who has already entered the event venue periodically or at a predetermined timing. In other words, the privilege information issuing apparatus may automatically recommend the privilege information to the corresponding user without depending on the privilege issuing request from the user.

Note that the privilege information issuing apparatus may execute the privilege information issuing processing at an arbitrary timing after the face authentication payment processing is completed. Then, the privilege information issuing apparatus may notify the user terminal of the issuing condition of the privilege information separately from the face authentication payment processing, that is, in advance as described above.

Note that the privilege information issuing apparatus may notify the user terminal of the current point balance or a point utilization target list in response to a request from the user. Specifically, the user terminal may display content in which the notification message 755, the reason for issuance 756, and the number of points to be issued 751 are not displayed in FIG. 23 described above. In this manner, an eco-friendly activity and a consumption action at the commercial facility in the neighborhood of the event venue of the user are promoted.

Note that the issuing condition of the privilege information is not limited to the face authentication payment and may include a success in identity authentication with an identity authentication terminal installed at a specific point in the area 4. Examples of the specific point include, but are not limited to, points to which it is desired to guide the user, such as a predetermined store or a sightseeing spot. For example, the issuing condition of the privilege information may include entry and exit through face authentication at a specific point, check-in through face authentication at an accommodation facility, and the like. In addition, a check-in confirmation method at a predetermined point is not limited to the identity authentication such as face authentication and the terminal information and may use global positioning system (GPS) information of the user terminal, position information of a WiFi base station, or the like.

Note that the aforementioned example embodiments have been described on the assumption that the identity authentication is based on the face authentication, the present disclosure is not limited thereto. In addition, although the description has been made on the assumption that the payment processing is based on the face authentication payment, the present disclosure may be applied to another payment method. In addition, the identity authentication at the time of issuing of the privilege information, the identity authentication at the time of entry or exiting of the event venue, and the identity authentication at the time of utilization of the privilege information in the commercial facility in the neighborhood of the event venue are also not limited to face authentication, and other identity authentication, which will be described later, may be applied.

In addition, although the aforementioned embodiments have been described on the assumption that the identity authentication (authentication for checking the identity, identity specification processing, and the like) is based on the face authentication, other biometric authentication using biometric information may also be performed. As the biometric authentication and the biometric information, other technologies using a captured image of a person can be applied. For example, as the biometric information, data (feature amount) calculated from physical characteristics unique to an individual such as a fingerprint, a voiceprint, a vein, a retina, an iris of a pupil, and a pattern (pattern) of a palm may be used. For the biometric authentication, feature information indicating the physical characteristics of a person may be extracted from the captured image of a part of the body of the user, the extracted feature information may be collated with feature information registered in advance, and the authentication may be regarded as being successful if the degree of matching is equal to or greater than the threshold value. For example, the biometric authentication may be authentication based on the appearance shape of the person. In this case, the feature information is information regarding the appearance shape of the person, for example, information indicating features such as a body shape, a height, and clothes. In addition, instead of the biometric authentication, another identity authentication may be applied, and the biometric information may also be another identity authentication information. Examples of the identity authentication information include, but are not limited to, a combination of a user ID, an ID, and a password, description contents (an identification number and the like or a password) of an identification card such as an individual number and a driver's license, an electronic certificate, code information, and the like. The code information may be a two-dimensional code, for example, a QR code (registered trademark).

Note that although the second example embodiment and the like are described on the assumption that the authentication apparatus 200 and the privilege information issuing apparatus 300 are different information processing apparatuses, the authentication apparatus 200 and the privilege information issuing apparatus 300 may be the same information processing apparatus. For example, the privilege information issuing apparatus 300 may further register the face feature information in association with the user ID 3121 of the user information 312. In this case, the control unit 340 only needs to further have the functions of the face detection unit 220, the feature point extraction unit 230, the registration unit 240, and the authentication unit 250 in FIG. 4.

Note that in the entry qualification information registration processing in FIG. 11 described above, the entry qualification information may not necessarily be registered using the success in face authentication as a condition. Alternatively, in a case where the user ID issued at the time of registration of the user information is stored in the user terminal, the user terminal may transmit a registration request including the user ID and the entry qualification information instead of the face image to the privilege information issuing apparatus 300 in Step S123. In that case, the privilege information issuing apparatus 300 may register the user ID and the entry qualification information included in the received registration request in an associated manner in user information. Alternatively, a sales server of the entry qualification information may transmit a registration request including the user ID and the entry qualification information of the purchaser to the privilege information issuing apparatus 300 at the time of purchasing the entry qualification information, and cause the privilege information issuing apparatus 300 to register the user ID and the entry qualification information.

Note that the entry qualification information registration processing in FIG. 11 described above may be performed by an information registration terminal instead of the user terminal 100. The information registration terminal may be, for example, a KIOSK terminal installed in a station or a commercial facility. In this case, the user terminal 100 transfers the entry qualification information to the KIOSK terminal, for example. Alternatively, the user inputs the entry qualification information to the KIOSK terminal. Then, the KIOSK terminal transmits the acquired entry qualification information and a face image obtained by imaging the user with the KIOSK terminal to the privilege information issuing apparatus 300. Note that in a case where a current location is used to issue the privilege information, the position information of the KIOSK terminal may be used. In addition, it is only necessary for the privilege information issuing apparatus 300 to notify the KIOSK terminal of the issued privilege information. At this time, the KIOSK terminal may display code information or the like of the privilege information such that the code information can be visually recognized by the user, and the user terminal may acquire the privilege information by scanning the code information displayed on the screen of the KIOSK terminal. Alternatively, the KIOSK terminal may print and output the code information or the like of the received privilege information. Alternatively, the privilege information issuing apparatus 300 may provide a notification of the privilege information issued with respect to the terminal information (user terminal) of the user specified by face authentication.

Note that the aforementioned issuing unit may select privilege information in accordance with attributes of the event, and issue and present the privilege information and notify the user of the privilege information. For example, in a case where the event is a sport game, a coupon that can be used at a support goods store may be issued to guide the user to the sales store. In addition, in a case where the event is a test, a coupon that can be used in a quiet cafe may be issued to guide the user to the cafe.

Note that the validity period (available period) of the privilege information may be a predetermined period such as several hours including at least one of a time zone before a start of the event or a time zone after the start, only the date of the event, or several weeks including the date of the event.

In the above-described example, the program includes a group of instructions (or software code) for causing a computer to perform one or more functions described in the example embodiments if the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### Supplementary Note A1

A privilege information issuing apparatus including:
an authentication control means for controlling identity authentication for a user who has purchased entry qualification information with which the user is able to enter an event venue through the identity authentication at a time of a payment by the user at a commercial facility in a neighborhood of the event venue;
an issuing means for issuing privilege information related to utilization of the event venue on the basis of information that is attributable to the payment in a case where the identity authentication has been successful; and
a notification means for notifying a terminal of the user of the issued privilege information.

### Supplementary Note A2

The privilege information issuing apparatus according to Supplementary Note A1, in which
the information that is attributable to the payment includes a payment price in the payment, and
the issuing means issues the privilege information including privilege content in accordance with the payment price.

### Supplementary Note A3

The privilege information issuing apparatus according to Supplementary Note A1 or A2, in which
the information that is attributable to the payment includes a type of a purchased product in the payment, and
the issuing means issues the privilege information in a case where the type of the purchased product is an eco-related product.

### Supplementary Note A4

The privilege information issuing apparatus according to any one of Supplementary Notes A1 to A3, in which
the information that is attributable to the payment includes content of an action carried out in relation to the payment, and
the issuing means issues the privilege information including privilege content in accordance with the content of the action.

### Supplementary Note A5

The privilege information issuing apparatus according to Supplementary Note A4, in which the content of the action includes an action related to global environment protection.

### Supplementary Note A6

The privilege information issuing apparatus according to Supplementary Note A5, in which the action related to the global environment protection includes at least any of utilization of public transportation or a bicycle to travel to the commercial facility or non-utilization of wrapping material in the payment.

### Supplementary Note A7

The privilege information issuing apparatus according to any one of Supplementary Notes A1 to A6, in which
the issuing means issues the privilege information by determining the number of points that can be used in paying money in relation to utilization of the event venue on the basis of the information that is attributable to the payment and adding the determined number of points to a balance of points of the user, and
the privilege information issuing apparatus further includes a utilization means for using points designated by the user in the balance of points for another privilege at the event venue.

### Supplementary Note A8

The privilege information issuing apparatus according to any one of Supplementary Notes A1 to A7, in which the commercial facilities are facilities in a cooperative relationship with the event venue.

### Supplementary Note B1

A privilege information issuing system including:
a storage apparatus that stores entry qualification information with which a user is able to enter an event venue through identity authentication and identity authentication information for registration of the user who has purchased the entry qualification information in an associated manner; and
a privilege information issuing apparatus that is connected to the storage apparatus,
in which the privilege information issuing apparatus includes
an authentication control means for controlling the identity authentication with reference to the storage apparatus using identity authentication information for authentication acquired from the user at a time of a payment by the user at a commercial facility in a neighborhood of the event venue,
an issuing means for issuing privilege information related to utilization of the event venue on the basis of information that is attributable to the payment in a case where the identity authentication has been successful, and
a notification means for notifying a terminal of the user of the issued privilege information.

### Supplementary Note B2

The privilege information issuing system according to Supplementary Note B1, in which
the information that is attributable to the payment includes a payment price in the payment, and
the issuing means issues the privilege information including privilege content in accordance with the payment price.

### Supplementary Note C1

A privilege information issuing method including, by a computer:
controlling identity authentication for a user who has purchased entry qualification information with which the user is able to enter an event venue through the identity authentication at a time of a payment by the user at a commercial facility in a neighborhood of the event venue;
issuing privilege information related to utilization of the event venue on the basis of information that is attributable to the payment in a case where the identity authentication has been successful; and notifying a terminal of the user of the issued privilege information.

### Supplementary Note D1

A non-transitory computer-readable medium that stores a privilege information issuing program that causes a computer to execute:
authentication control processing of controlling identity authentication for a user who has purchased entry qualification information with which the user is able to enter an event venue through the identity authentication at a time of a payment by the user at a commercial facility in a neighborhood of the event venue;
issuing processing of issuing privilege information related to utilization of the event venue on the basis of information that is attributable to the payment in a case where the identity authentication has been successful; and
notification processing of notifying a terminal of the user of the issued privilege information.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### Reference Signs List

1 PRIVILEGE INFORMATION ISSUING APPARATUS
11 AUTHENTICATION CONTROL UNIT
12 ISSUING UNIT
13 NOTIFICATION UNIT
1000 PRIVILEGE INFORMATION ISSUING SYSTEM
N NETWORK
U1 USER
U21 FACILITY STAFF
U2n FACILITY STAFF
U3 AREA STAFF
100 USER TERMINAL
110 STORAGE UNIT
111 PROGRAM
112 TERMINAL INFORMATION
120 MEMORY
130 COMMUNICATION UNIT
140 CAMERA
150 TOUCH PANEL
160 CONTROL UNIT
161 REGISTRATION UNIT
162 PRIVILEGE PROCESSING UNIT
200 AUTHENTICATION APPARATUS
210 FACE INFORMATION DB
211 USER ID
212 FACE FEATURE INFORMATION
220 FACE DETECTION UNIT
230 FEATURE POINT EXTRACTION UNIT
240 REGISTRATION UNIT
250 AUTHENTICATION UNIT
300 PRIVILEGE INFORMATION ISSUING APPARATUS
310 STORAGE UNIT
311 PROGRAM
312 USER INFORMATION
3121 USER ID
3122 TERMINAL INFORMATION
3123 ATTRIBUTE INFORMATION
3124 PAYMENT INFORMATION
3125 ENTRY QUALIFICATION INFORMATION
313 PRIVILEGE INFORMATION MASTER
3131 PRIVILEGE ID
3132 TARGET FACILITY
3133 PRIVILEGE CONTENT
3134 ISSUING CONDITION
314 EVENT INFORMATION
315 PRIVILEGE MANAGEMENT INFORMATION
3151 ISSUED PRIVILEGE ID
3152 USER ID
3153 ISSUING DATE AND TIME
3154 VALIDITY PERIOD
320 MEMORY
330 COMMUNICATION UNIT
340 CONTROL UNIT
341 REGISTRATION UNIT
342 AUTHENTICATION CONTROL UNIT
343 SPECIFICATION UNIT
344 ISSUING UNIT
345 NOTIFICATION UNIT
346 ENTRY DETERMINATION UNIT
347 PAYMENT CONTROL UNIT
4 AREA
40 EVENT VENUE
401 ENTRY CONTROL TERMINAL
402 EVENT HALL
41 COMMERCIAL FACILITY
51 PAYMENT TERMINAL
61 MANAGEMENT TERMINAL
4n COMMERCIAL FACILITY
5n PAYMENT TERMINAL
6n MANAGEMENT TERMINAL
600 MANAGEMENT TERMINAL
410 STORAGE UNIT
411 PROGRAM
412 TERMINAL INFORMATION
420 MEMORY
430 COMMUNICATION UNIT
440 CAMERA
450 TOUCH PANEL
460 CONTROL UNIT
461 RECEPTION UNIT
462 ENTRY CONTROL UNIT
510 STORAGE UNIT
511 PROGRAM
512 TERMINAL INFORMATION
520 MEMORY
530 COMMUNICATION UNIT
540 CAMERA
550 TOUCH PANEL
560 CONTROL UNIT
561 RECEPTION UNIT
562 PAYMENT CONTROL UNIT
71 COUPON
711 TARGET FACILITY
712 VALIDITY PERIOD
713 PRIVILEGE CONTENT
714 CODE INFORMATION
715 NOTIFICATION MESSAGE
716 REASON FOR ISSUANCE
72 COUPON
721 TARGET FACILITY
722 VALIDITY PERIOD
723 PRIVILEGE CONTENT
724 CODE INFORMATION
725 NOTIFICATION MESSAGE
726 REASON FOR ISSUANCE
73 COUPON
731 TARGET FACILITY
732 VALIDITY PERIOD
733 PRIVILEGE CONTENT
734 CODE INFORMATION
735 NOTIFICATION MESSAGE
736 REASON FOR ISSUANCE
74 COUPON
741 TARGET FACILITY
742 VALIDITY PERIOD
743 PRIVILEGE CONTENT
744 CODE INFORMATION
745 NOTIFICATION MESSAGE
746 REASON FOR ISSUANCE
75 COUPON
751 NUMBER OF ISSUED POINTS
752 POINT BALANCE
753 VALIDITY PERIOD
754 TARGET FACILITY
755 NOTIFICATION MESSAGE
756 REASON FOR ISSUANCE
76 POINT UTILIZATION TARGET LIST
760 NUMBER OF NECESSARY POINTS
761 COUPON
762 COUPON
763 COUPON
764 EXCHANGE TO OTHER POINTS
1000a PRIVILEGE INFORMATION ISSUING SYSTEM
300a PRIVILEGE INFORMATION ISSUING APPARATUS
4n+1 COMMERCIAL FACILITY
5n+1 PAYMENT TERMINAL
U1-2 USER
100-2 USER TERMINAL
300b PRIVILEGE INFORMATION ISSUING APPARATUS
311b PROGRAM
3126 POINT BALANCE
3133b NUMBER OF POINTS
316 POINT UTILIZATION TARGET MASTER
3161 UTILIZATION TARGET ID
3162 UTILIZATION CONTENT
3163 NUMBER OF NECESSARY POINTS
344b ISSUING UNIT
348 UTILIZATION UNIT
770 NOTIFICATION MESSAGE
771 ISSUING CONDITION
772 ISSUING CONDITION
773 ISSUING CONDITION
774 ISSUING CONDITION

What is claimed is:

1. A privilege information issuing apparatus comprising:
at least one storage device configured to store instructions; and
at least one processor configured to execute the instructions to:
control identity authentication for a user who has purchased entry qualification information with which the user is able to enter an event venue through the identity authentication at a time of a payment by the user at a commercial facility in a neighborhood of the event venue;
issue privilege information related to utilization of the event venue on the basis of information that is attributable to the payment in a case where the identity authentication has been successful; and
notify a terminal of the user of the issued privilege information.

2. The privilege information issuing apparatus according to claim 1, wherein
the information that is attributable to the payment includes a payment price in the payment, and
wherein the at least one processor is further configured to execute the instructions to:
issue the privilege information including privilege content in accordance with the payment price.

3. The privilege information issuing apparatus according to claim 1, wherein
the information that is attributable to the payment includes a type of a purchased product in the payment, and
wherein the at least one processor is further configured to execute the instructions to:
issue the privilege information in a case where the type of the purchased product is an eco-related product.

4. The privilege information issuing apparatus according to claim 1, wherein
the information that is attributable to the payment includes content of an action carried out in relation to the payment, and
wherein the at least one processor is further configured to execute the instructions to:
issue the privilege information including privilege content in accordance with the content of the action.

5. The privilege information issuing apparatus according to claim 4, wherein the content of the action includes an action related to global environment protection.

6. The privilege information issuing apparatus according to claim 5, wherein the action related to the global environment protection includes at least any of utilization of public transportation or a bicycle to travel to the commercial facility or non-utilization of wrapping material in the payment.

7. The privilege information issuing apparatus according to claim 1, wherein the at least one processor is further configured to execute the instructions to:
issue the privilege information by determining the number of points that can be used in paying money in relation to utilization of the event venue on the basis of the information that is attributable to the payment and adding the determined number of points to a balance of points of the user, and
use points designated by the user in the balance of points for another privilege at the event venue.

8. The privilege information issuing apparatus according to claim 1, wherein the commercial facility is a facility that is in a cooperative relationship with the event venue.

9. A privilege information issuing system comprising:
a storage apparatus that stores entry qualification information with which a user is able to enter an event venue through identity authentication and identity authentication information for registration of the user who has purchased the entry qualification information in an associated manner; and
a privilege information issuing apparatus that is connected to the storage apparatus, and including:
at least one storage device configured to store instructions; and
at least one processor configured to execute the instructions to:
control the identity authentication with reference to the storage apparatus using identity authentication information for authentication acquired from the user at a time of a payment by the user at a commercial facility in a neighborhood of the event venue,
issue privilege information related to utilization of the event venue on the basis of information that is attributable to the payment in a case where the identity authentication has been successful, and
notify a terminal of the user of the issued privilege information.

10. The privilege information issuing system according to claim 9, wherein
the information that is attributable to the payment includes a payment price in the payment, and
wherein the at least one processor is further configured to execute the instructions to:
issue the privilege information including privilege content in accordance with the payment price.

11. A privilege information issuing method comprising, by a computer:
controlling identity authentication for a user who has purchased entry qualification information with which the user is able to enter an event venue through the identity authentication at a time of a payment by the user at a commercial facility in a neighborhood of the event venue;
issuing privilege information related to utilization of the event venue on the basis of information that is attributable to the payment in a case where the identity authentication has been successful; and
notifying a terminal of the user of the issued privilege information.

12. A non-transitory computer-readable medium that stores a privilege information issuing program that causes a computer to execute:
authentication control processing of controlling identity authentication for a user who has purchased entry qualification information with which the user is able to enter an event venue through the identity authentication at a time of a payment by the user at a commercial facility in a neighborhood of the event venue;
issuing processing of issuing privilege information related to utilization of the event venue on the basis of information that is attributable to the payment in a case where the identity authentication has been successful; and
notification processing of notifying a terminal of the user of the issued privilege information.
